(19) United States
(12) Patent Application Publication
(10) Pub. No.: US 2002/0178223 A1
(43) Pub. Date: Nov. 28, 2002

(54) System and method for disseminating knowledge over a global computer network

(76) Inventor: Arthur A. Bushkin, McLean, VA (US)

Correspondence Address: Michael D. Bednarek, SHAW PITTMAN LLP, 1650 Tysons Boulevard, McLean, VA, 22102, US

(21) Appl. No.: 10/151,878

(22) Filed: May 22, 2002

Related U.S. Application Data
(60) Provisional application No. 60/292,626, filed on May 23, 2001.

(51) Int. Cl. G06F 15/16

(52) U.S. Cl. 709/205; 709/213

(57) ABSTRACT

Systems and methods for disseminating knowledge over a global computer network, including a system and method for administering a quest over a computer network, a method for cataloging a resource (e.g., a web page) available on a computer network, and a method for categorizing content stored on a computer network. Embodiments of the invention also provide user interfaces for navigating through a web site.

This application claims the benefit of U.S. Provisional Application No. 60/292,626, filed May 23, 2001, which is herein incorporated by reference in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The present invention relates to a broad-based platform and portal that facilitates the dissemination of knowledge, and more specifically, to a system and method that allows users to package their knowledge and experiences with existing resources on a global computer network, and to share such packages using unique collaborative tools and the communication capabilities of the global computer network.

1. Background of the Invention

As a vast repository of information, the World Wide Web (the “Web”) possesses unlimited potential for empowering users with knowledge. Unfortunately, the sheer volume of information presents a significant obstacle to harnessing this potential. By the Web's very nature, content is widely distributed and difficult to locate. Search engines provide some guidance, but their scope is limited, covering well under half of the available web content. Thus, because of the absence of tools to organize and share content, users are often left to browse the Web with little guidance and modest success.

Notwithstanding the current inadequate information tools, users of all kinds look to the Web to gain information and communicate with colleagues, associates, and friends. Of particular relevance to the present invention, users in the fields of education, nonprofit organizations, and the government can benefit greatly from the informational resources available on the Web, but only to the extent that they can locate, organize, customize, and efficiently share and teach others about the information.

The information management challenges in the fields of education, nonprofit organizations, and government are both diverse and overlapping. In the field of education and teaching, the challenges in managing information include providing students with access to the information, which may be located on the Web, and providing students with access to the knowledge and experience of the teachers who help guide the process of learning, which is generally not located on the Web. The challenges also include improving efficiency, effectiveness, and collaboration among teachers, students, and other participants in the learning process. For nonprofit organizations, the challenges of managing information also include communicating with constituents, aggregating information for constituents, and communicating with field staff and other organizations. In government, the challenges include providing citizens with access to government information and supporting communication between government officials and constituents.

For each of these challenges, the Internet and the Web are able provide the raw information on a global basis, but lack the tools to manage it. Thus, although the Web abounds in content that could empower educators, nonprofit organizations, and government entities, there is still a need for tools for finding the information, for organizing the information in logical and useable packages, for sharing and guiding the learning of the information, and for enhancing the information with the insights and contributions of others.

To understand the typical drawbacks to managing Web content, one must simply consider the manner in which content is organized. Each web page accessible through the Web is an information resource. The location of an information resource on the Web is typically expressed by a unique address called a Uniform Resource Locator (URL). Conventional directories, search engines, and other conventional information location tools can assist in identifying and accessing information resources on the Web, typically, by presenting lists of URLs in response to researcher-defined queries. However, the lists require a user to investigate each individual link to find desired content. In addition, the ordinary searching tools do not allow a user to associate particular URLs from the list into a preferred list that the user can share with other users. The ordinary searching tools also do not allow the user to integrate her own content, knowledge, and experience into the search results and to save the integrated content into a customized information package.

The drawbacks to traditional Web searching tools are especially problematic for teachers and educators, who recognize that a valuable learning experience is built on the fluid exchange of ideas between and among teachers and students. As an example, a teacher could, using conventional search tools, search the Web for a particular topic and provide her students with a list of URLs to review. As a part of the exercise, the teacher could require the students to write an essay summarizing the content available in the URLs and, perhaps, could also encourage the students to conduct further research to find additional information on the Web. Each student would then independently review the URLs, conduct his or her own research to find additional URLs, and return the resulting essay to the teacher through some means of communication unrelated to the list of URLs, for example, as an email or a hard copy of the essay delivered to the teacher.

In the end, this method of teaching is limited to two steps of communication: assignment of the task and returning results. The students are simply directed to Web content, without a means for exchanging ideas about that content with the teacher. In such exchanges, the teacher could respond to students' needs for more guidance, could provide her own knowledge and experience related to the particular topic, and could use the valuable input of students, or even other teachers, to build a better selection of Web content, i.e., a better list of URLs. Thus, although conventional searching tools can help locate content, educators would prefer a communication layer built over that content, which facilitates an open forum of learning in which teachers and students can exchange ideas about the content, add to the content, and share their own knowledge and experience related to the content.

Thus, what educators truly desire is an educator-structured, student-guided educational experience with enhanced communication tools. Unfortunately, educators and students cannot use existing information location tools to realize the full potential of the Web as a repository of and delivery mechanism for information and educational resources. And, on a broader level, web users in general cannot fully exploit the information resources available through the Web because of the deficient information location tools.

It is important to note that some of the functionality of the present invention can be provided in an ad hoc fashion using existing tools if the user has sufficient expertise and the requisite skill in computer languages, coding, and/or application usage. The problem, however, is that many people that could provide valuable contributions by combining their knowledge and experience with the content available on the Web are prevented from doing so by the technical challenges noted above. Thus, there remains a need for a user-friendly platform that provides access to the resources of the Web while providing a system and method that facilitates and simplifies the process of combining a user's knowledge and experience with the resources available on the Web.

### SUMMARY OF THE INVENTION

The present invention is a broad-based platform, portal, and tool that facilitates the dissemination of knowledge. Building on existing web content, the present invention provides the capabilities and tools with which users can participate in online communities, enabling the correspondence, learning, and the exchange of ideas and information within a communications layer built upon the web content. The present invention facilitates a vibrant and evolving exchange of information, knowledge, and experiences through unique software tools that mimic places and tools familiar to a typical user, e.g., a library, a classroom, a college, a community center, a museum, and communications services such as email, instant messaging, chat, message boards, and online events.

The present invention provides the ability to perform detailed searches for valuable web-based content in an online living library. The library is a comprehensive collection of web resources and tools specific to the programs and activities of a particular organization, such as educational institutions, volunteer organizations, nonprofit organizations, and the government.

The present invention also facilitates collaboration among users of a global computer network through the use of interactive web-based tools such as online meetings, discussion boards, and moderated chats.

The present invention unleashes the full potential of web accessible information resources (IRs) by providing a system and method for building and managing IRs. According to a representative embodiment, the present invention allows a user to locate, catalog, and communicate about all forms of information locatable using a URL address. The user can also supplement the information with her own knowledge and experience, included for the purpose of guiding others through the process of learning the information. In encouraging users to locate and catalog information resources, and to contribute their own content and guidance, the present invention promotes an “organic knowledge”—a knowledge that becomes more comprehensive and refined with each new user.

A representative embodiment of the present invention allows a person to create and manage a special type of IR, referred to herein as an educational resource (ER). The ER is a novel form of self-guided educational experience composed of, among other things, questions and corresponding URLs that identify the location of other ERs that may be used to answer the questions. In this manner, this representative embodiment of the present invention provides access to innovative guided learning experiences and other online educational resources.

For illustration purposes, this specification describes the present invention in the context of education, volunteer organizations, nonprofit organizations, and the government. However, as one of ordinary skill in the art would appreciate, the present invention is useful to any user desiring to disseminate knowledge. Moreover, in addition to education, volunteer organizations, nonprofit organizations, and the government, the present invention can be used in the context of other activities, such as philanthropic organizations, trade associations, and even commercial enterprises. For that reason, and notwithstanding the particular benefits associated with using the present invention in connection with education, nonprofit organizations, and the government, the system and method described herein is broadly useful in the context of information exchange over a global computer network.

A representative embodiment of the present invention includes one or more of the features discussed below.

Tagging Features

Tagging features enable a user to catalog an ER for one or more educational purposes. Specifically, the present invention permits a user to store a record (also referred to herein as a tag or StarTag) in an electronic database (also referred to herein as a library) containing information about an ER, including one or more of: 1) the URL associated with the ER; 2) a description of the ER; and 3) a classification or key word for locating the ER. Once an ER is cataloged, any user of the present invention may search for and identify the ER (and similarly addressed, described, or classified ERs), and perform functions involving the ER such as: 1) displaying; 2) printing; and 3) recataloging using a modified description or classification. These features are referred to herein as “StarTag Features.”

Communicator Features

Communicator features enable a user to communicate with other persons about one or more ERs. Specifically, the present invention permits a user to initiate and engage in various modes of communication including: 1) e-mails; 2) chat rooms; 3) message boards; 4) instant messages; 5) audio transmissions over the Web; and 6) audio-video transmissions over the Web. These aspects of the present invention are referred to herein as “Communicator Features.”

Quests and Quest Creator Features

This feature enables a user to create, define, catalog, and modify a novel form of ER referred to herein as an “educational quest,” “quest,” or “StarQuest.” From a functional perspective, a quest is a package of web information and user knowledge and experience that quest takers can review and, optionally, with which quest takers can interact. As an example, a quest could be a structured, self-guided lesson plan designed for one or more educational purposes. As used herein, a quest taker (also referred to herein as a questor) refers both to a user who reviews a quest and enters content (e.g., answer questions or adds relevant web pages) and to a user who simply reviews a quest without entering additional content.

From a technical perspective, a quest is an electronic database record including one or more of: 1) a title; 2) a mission statement; 3) a classification; 4) a reference list of ERs relevant to successfully completing the quest; 5) one or more questions to be answered by the persons or person who choose(s) to engage in the quest; 6) a checklist of other information, including ancillary questions, hints, recommendations, and similar or related quests; and 7) notes (e.g., in the form of a memo) recorded by a user in creating or engaging in a quest. The quest creator also may customize the manner or style in which quests are displayed to the quest taker.

Among other things, Quests and Quest Creator Features enable a creator or administrator of a quest to: 1) create a quest; 2) edit a quest; 3) specify a list of quest takers who are permitted to take a quest and return responses to the quest administrator; and 4) save the quest in a library for use and modification by other quest creators and administrators.

An embodiment of the present invention also gives a quest creator the ability to collaborate within a designated group, such as a class of students (e.g., Ms. Smith's 3^{rd} grade class in Augusta, Me.). This group collaboration includes features that: 1) add password protection to the quest; 2) permit group members to view each others' responses to the quest; 3) aggregate and tabulate the responses of all group members; and 4) permit group members to develop a shared or jointly-authored response to the quest. In addition to teaching environments, this collaboration tool provides significant benefits to nonprofit organizations in meeting their management and governance needs (e.g., in managing a board of directors selection process, in strategically analyzing a public relations campaign, and in establishing best practices).

The foregoing aspects of the present invention are referred to herein as “Quest Creator Features.”

Quest Mission Features

In addition to providing features for defining and cataloging quests, an embodiment of the present invention further provides a user with a graphical user interface (GUI) and user-specific electronic data storage capacity, referred to herein as “Quest Mission Features,” that enable the user to engage in a quest. Among other things, Quest Mission Features enable a taker of a quest to: 1) search for a quest; 2) select a quest; 3) commence a quest; 4) navigate a series of dynamically generated GUIs used to display, receive, and store information relevant to completing questions comprising the quest; 5) review the user-specific stored information relevant to the quest; and 6) catalog a description or other information reflecting the user's opinion about the quest, which could include a rating of the quest.

According to embodiments of the present invention, a quest taker can engage in a quest through an online GUI or, alternatively, can download the content of a quest for manipulation by desktop software, such as word processing software. This latter method of quest taking is especially useful when online computer access is expensive or unavailable.

Clusters

This feature provides a novel method for categorizing content into customized directories, referred to herein as “clusters” and “StarClusters.” These clusters enable a user to create personal directories of information that may be easily managed and shared among users. According to the method, a user identifies, within a general directory, a subset of specific collections or categories of information. This subset functions both as a user-defined portal for specific categories of interest and also as a personal directory.

One novel aspect of a cluster is its ability to automatically provide access to new information as that information is cataloged using the StarTag Features. For instance, by defining a cluster to include the category “soccer camps,” a user who accesses the cluster over time will see new information, including information in the form of new StarTags, added (by any user) using the “soccer camps” category. Conceptually, using a library analogy, a cluster is like a patron-specific shelf in a library that is populated with certain patron-defined categories of books and is supplemented, by the librarian, with additional books that fill in the patron-defined categories as those books are added to the library's collection.

FIG. 9A compares an exemplary StarCluster to a conventional general directory. This particular StarCluster is a personal directory for “Drama and Soccer Camps” and, as such, associates the smaller categories of soccer, drama, and camps from among the larger categories of arts, sports, and youth in the general directory. The StarCluster therefore provides a focused source of information that a user can build and share with other users—a source of information that grows automatically as other users add new information under the categories defined in the StarCluster.

This dynamic method for categorizing content provides significant benefits over traditional static portals, which typically are less precise in associating content and do not provide ways to create and preserve new categories of information (such as the personal directory, StarCluster). For example, as shown by the conventional general directory of FIG. 9A, a traditional portal might simply associate the general categories of arts, sports, and youth in a general directory. This inferior method for categorizing would include a large amount of irrelevant information for a user seeking information on “Drama and Soccer Camps.” The user would have to “drill down” into the hierarchy to find pertinent information and, perhaps, perform other advanced search techniques.

In contrast to prior methods for categorizing content, the clusters of an embodiment of the present invention create a taxonomy that is customized for the individual needs and interests of a user and that effectively filters out unwanted information. Taxonomy, as used herein, is a classification system consisting of categories and subcategories, which provide a conceptual framework for information storage and retrieval.

Navigation Tool

According to one embodiment, the present invention provides a navigation tool, which is a unique GUI that provides a main view screen surrounded by persistent view areas. The persistent view areas provide header information, control information, user instructions, and location indicators. Always-present control functions and user instructions enable a user to conveniently navigate and operate the web site, and to focus her attention on the more complex functions of manipulating information accessed through the main view screen of the web site.

The location indicators provide a user with a visual tool with which to understand and execute the functions of a web site. Through a combination of two- and three-dimensional icon displays, a user can jump from function to function and complete desired tasks on the web site. Rather than traversing the cumbersome menu hierarchies of traditional web sites, a user can use the logical interrelationships of the icon displays to navigate through desired tasks. The unique icon displays also enable a web site administrator to easily expand a web site without complicating a user's understanding of available functions.

Benefits of the Invention

A representative embodiment of the present invention may include the following aspects:

The ability to catalog, locate, and communicate about IRs—the informational building blocks of the Web—using a method that offers a richer educational experience than conventional information location tools.

The ability to build, modify, and engage in “quests,” a novel form of ER, that may be used to provide structured, self-guided education on any conceivable subject matter.

An aspect of the present invention provides a method for disseminating knowledge over a computer network that includes receiving, from a first user, information defining a quest; storing the information in a quest record that is marked with a unique identifier, wherein the quest record is accessible to a plurality of users; receiving, from the first user, instructions to associate the quest with network addresses of resources available through the computer network; storing the network addresses in tag records, wherein the tag records reference the unique identifier; receiving a request to take the quest from a second user; retrieving the quest record associated with the quest; determining the unique identifier of the quest record; identifying tag records that reference the unique identifier; displaying, to the second user, network addresses of the tag records that include the unique identifier; and providing access to the network addresses of the tag records that include the unique identifier.

Another aspect of the present invention provides a method for disseminating knowledge over a computer network including receiving, from a first user, a description of a task; receiving, from the first user, an indication to associate the description with a network address of a resource available through the computer network; storing the description and the network address in a database that is accessible through the computer network; associating the description with the network address; receiving a query from a second user to search for a search term in the database; and if the description of the task includes the search term, displaying the description to the second user and providing the second user with access to the network address.

Another aspect of the present invention provides a system for administering a quest that includes a computer network accessible to a plurality of users, a quest database, a tag database, and a computer in communication with the computer network, the quest database, and the tag database. The quest database contains quest records. A quest record contains a unique identification. The tag database contains resource records. A resource record contains a network address associated with a particular resource available through the computer network and a unique identification of a quest record with which the resource record is associated. The computer is adapted to retrieve from the quest database a quest record having a designated unique identification, to search the tag database for resource records containing the designated unique identification, and to display resources of the resource records containing the designated unique identification.

Another aspect of the present invention provides a method for disseminating knowledge over a computer network including receiving, from a first user, a network address of a resource available over the computer network; receiving, from the first user, a classification term identifying the resource; storing the network address with the classification term in a database accessible to a plurality of users; receiving, from a second user, a search query asking for network addresses relating to a search term; searching the database for the search term; and displaying the network address designated by the first user if the classification term is equivalent to the search term.

Another aspect of the present invention provides a method for cataloging web pages available on the World Wide Web. The method includes receiving, from a plurality of users, Uniform Resource Locator addresses of web pages; receiving, from the plurality of users, classifications of the web pages; storing the addresses with their classifications in a database accessible through the World Wide Web; receiving, from a user, a query for web pages related to a search term; searching the classifications of the database for the search term; and displaying addresses having classifications containing the search term.

Another aspect of the present invention provides a method for categorizing content stored on a computer network including designating a cluster adapted to be associated with resources available through the computer network, wherein the cluster is associated with a user, and wherein the cluster includes at least one category of interest to the user; creating a record for a resource that is accessible through the computer network; associating a classification of the resource with the record, wherein the classification corresponds to a category of the at least one category of interest; and associating the record with the category in the cluster.

Another aspect of the present invention provides a user interface for navigating through a web site on a computer network, including a view area, a header area, a tactical area, and a control panel area. The view area is adapted to display content of the web site. The view area is fixed in a first location on the user interface and the content scrolls within the view area. The header area is adapted to receive commands to execute functions relating to the web site. The header area is fixed in a second location on the user interface. The tactical area is adapted to display instructions related to the content displayed in the view area. The tactical area is fixed in a third location on the user interface and updates the displayed instructions as the content displayed in the view area changes. The control panel area is adapted to receive commands to execute functions in the view area. The control panel is fixed in a fourth location on the user interface and updates functions available to a user based on the content contemporaneously displayed in the view area.

Another aspect of the present invention provides a user interface for navigating through a web site on a computer network, including a first view area and a second view area. The first view area is adapted to display icons in a two-dimensional view. The icon corresponds to a function executable on the web site. The first view area is adapted to receive commands to execute functions corresponding to the icons. The second view area is adapted to display a three-dimensional view of the icons of the first view area. The three-dimensional view is from a perspective of an icon corresponding to a function being executed.

Accordingly, an object of the present invention is to facilitate the dissemination of knowledge over a global computer network.

Another object of the present invention is to facilitate communication and collaboration between organizations and their members, especially philanthropic and educational organizations.

Another object of the present invention is to build an active library of information, knowledge, and experience, which, in addition to enabling the storage and retrieval of information, includes a communications vehicle that affords opportunities to collaborate, share information, and hold online events

These and other objects, aspects, and advantages of the present invention are described in greater detail in the detailed description of the invention and the attached materials. Additional features and advantages of the invention will be set forth in the description that follows, will be apparent from the description, or may be learned by practicing the invention.

### BRIEF DESCRIPTION OF THE DRAWINGS

FIG. 1 is a schematic diagram of an exemplary network computer system of the present invention, according to a representative embodiment.

FIG. 2A is a schematic diagram illustrating the Tagging Features of the present invention, according to a representative embodiment.

FIG. 2B is a screen image illustrating an exemplary user interface for creating a tag record in a tag database, according to an embodiment of the present invention.

FIG. 2C is a screen image illustrating an exemplary user interface for creating a tag record within the context of creating a quest, according to an embodiment of the present invention.

FIG. 3 is a schematic diagram illustrating the Quest Features of the present invention, according to a representative embodiment.

FIGS. 4A to 4M are screen images illustrating an exemplary process for creating a quest, according to a representative embodiment of the present invention.

FIGS. 5A to 5H are screen images illustrating an exemplary process for selecting and participating in a quest, according to a representative embodiment of the present invention.

FIG. 6 is a schematic diagram of an exemplary graphical user interface, according to a representative embodiment of the present invention.

FIGS. 7 and 8 are schematic diagrams of exemplary navigational windows, according to representative embodiments of the present invention.

FIGS. 9A-9C are schematic diagrams comparing conventional general directories to exemplary clusters of the present invention, according to embodiments of the present invention.

### DETAILED DESCRIPTION

System Architecture

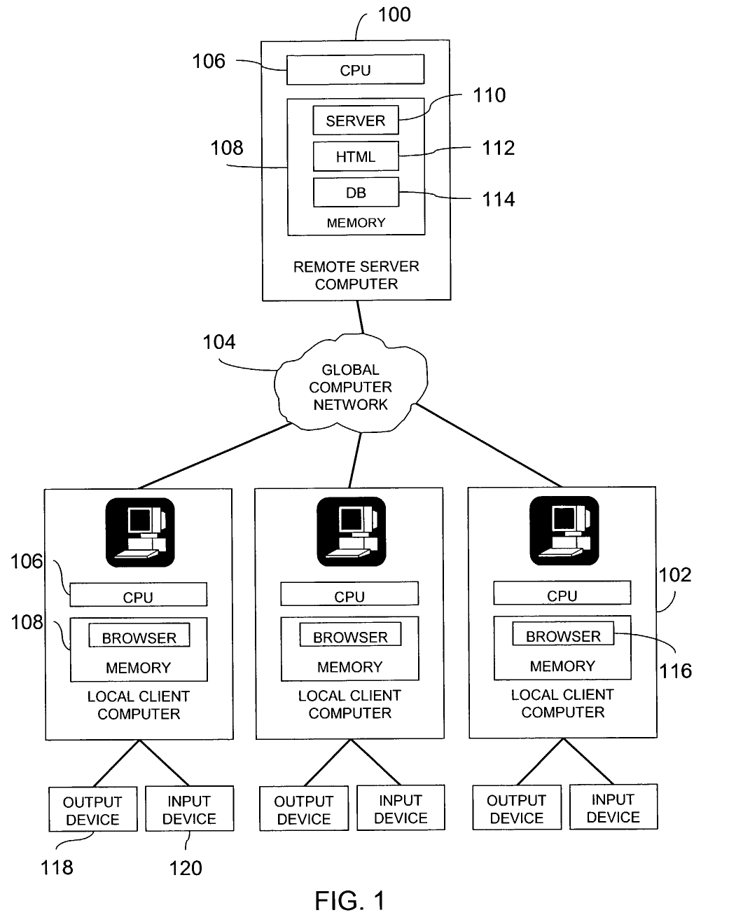

According to a representative embodiment, the present invention is deployed on a computer system of networked computers, such as computers connected via the Internet. FIG. 1 shows a representative computer system including a server computer 100 in communication with client computers 102 through a global computer network 104, such as the Internet. Server computer 100 and client computers 102 each have a central processing unit (CPU) 106 and memory 108. Memory 108 of server computer 100 includes databases 114, web pages 112 in hypertext markup language (HTML) or a similar protocol, and a server computer program 110 used to transmit and receive data, including database records and web pages. Memory 108 of client computers 102 includes a browser computer program 116 used to transmit and receive data, including database records and web pages. Client computers 102 also have an output device 118 (e.g., a monitor or a printer) and an input device 120 (e.g., a keyboard).

Tagging

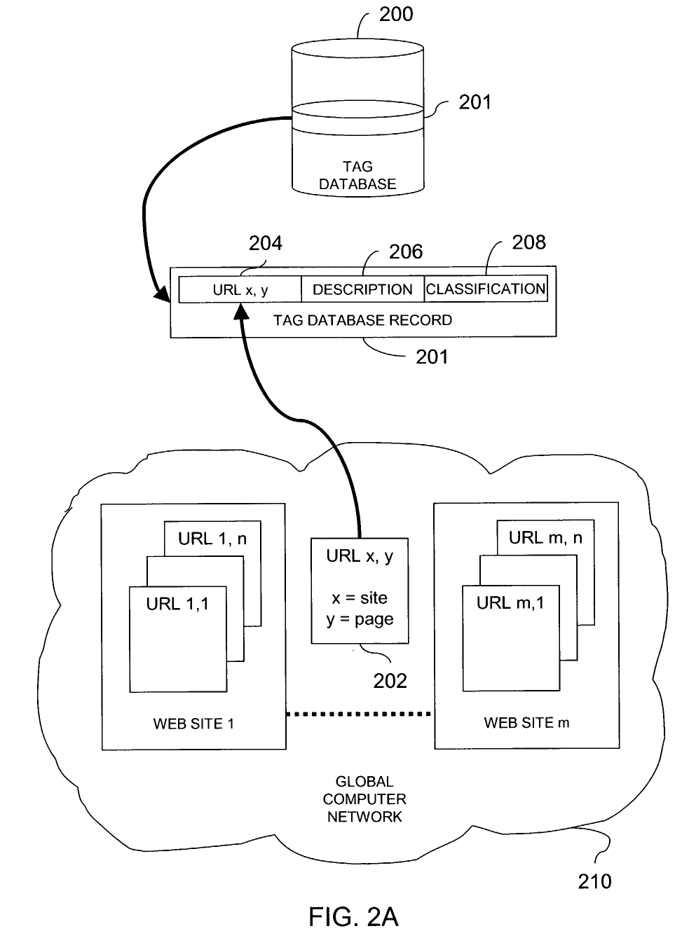

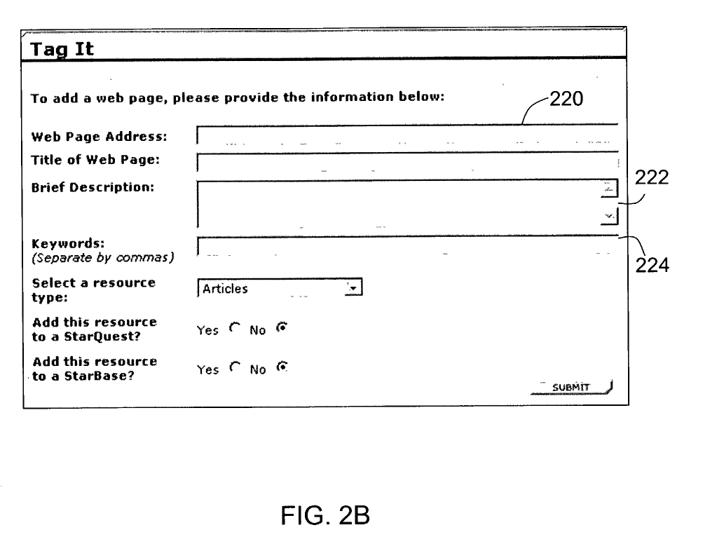

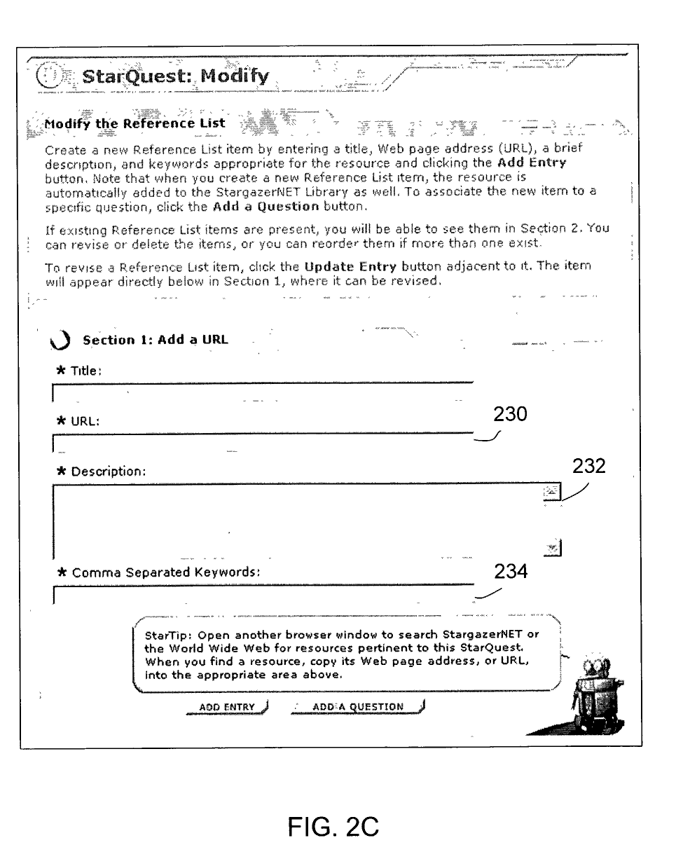

FIGS. 2A-2C illustrate a representative embodiment of the Tagging Features of the present invention. As shown, the Tagging Features use a tag database 200 (or library) in which each database record 201 associates a web page 202 with a URL 204, a description 206, and one or more classifications, categories, or key words 208. In an embodiment of the present invention, server computer 100 of FIG. 1 would contain tag database 200.

URL 204 identifies the location at which web page 202 can be found. Web page 202 is part of any web site located on global computer network 210, e.g., any web site from web site 1 to web site m. Web page 202 could contain, for example, articles, curricula, media clips, reports, pictures, charts, events, web broadcasts, or biographies. Web page 202 could also contain a quest as discussed in more detail below.

Description 206 identifies the type of resource being tagged, for example, an article, a media clip, a report, or a picture. Classification 208 indicates the subject(s) under which the tag should be filed in the library. The user who creates tag database record 201 can define classification 208. Alternatively, the system of the present invention automatically selects classification 208 for the web page based on the page's actual content, as well as on any key words suggested by the web page creator.

In the context of tagging, the present invention focuses on web pages, rather than web sites, because web sites generally encompass diverse content that cannot be easily filed within a single resource description or within a few useful subject matter categories. Web pages, on the other hand, typically provide more narrowly defined content with specific types of information, such as text, graphics, audio, and/or video. In this respect, the present invention views web pages as the “atomic element” of the web. Tagging web pages, rather than web sites, therefore affords a more powerful information resource in that users are routed directly to the pertinent content, instead of landing on a web site and having to browse without guidance.

FIGS. 2B and 2C illustrate two exemplary methods by which a user can create a tag record 201. FIG. 2B shows an exemplary user interface through which a user enters a tag record 201 directly into tag database 200. In URL field 220, the user enters the URL of the web page that the user wishes to catalog. URL field 220 corresponds to URL 204 of the tag record 201. In description field 222, the user enters a short description of the web page, which corresponds to description 206 of the tag record 201. Finally, in key word field 224, the user enters search terms under which the web page should be classified. These terms populate classification 208 of the tag record 201. Optionally, as shown in FIG. 2B, additional information can be included in a tag record 201, such as the title of the web page, the type of resource available on the web page (e.g., article), and whether the resource is associated with a StarQuest or StarBase (which is a customized web page that aggregates and provides access to web resources associated with an individual user, an organization, or a particular topic). With all of the fields complete, the new tag record 201 is added to tag database 200 and is made available to all users (e.g., by browsing or by searching for the key words of classification 208).

Similar to the user interface of FIG. 2B, the user interface shown in FIG. 2C enables a user to create a tag record 201, but, in this case, within the context of creating a quest (discussed in more detail below). As shown, the user enters the URL of the desired web page into URL field 230, which corresponds to URL 204 of tag record 201. In description field 232, the user enters a short description of the desired web page, which corresponds to description 206 of the tag record 201. Finally, in key word field 234, the user enters search terms under which the web page should be classified. These terms populate classification 208 of the tag record 201. Optionally, as shown in FIG. 2C, additional information can be included in a tag record 201, such as the title of the web page. With all of the fields complete, the new tag record 201 is added to tag database 200 and is made available to all users (e.g., by browsing or by searching for the key words in classification 208).

In a further embodiment of the present invention, quests are stored as tag records in tag database 200. After a user creates a quest, an entry for the quest is added to tag database 200, including the URL 204 of the quest and its description 206 and classification 208. Then, like any other tagged web page, the quest becomes a searchable web resource within the library of resources of tag database 200.

In another embodiment of the present invention, tag database 200 contains only one tag database record 201 for any given URL 204. In other words, upon receiving a request from a user to add a tag record 201 for a particular URL (through, for example, the user interfaces shown in FIGS. 2B and 2C), a software application running on remote server computer 100 checks tag database 200 to determine whether that particular URL is listed in tag database 200. If a tag record 201 already exists for that particular URL, then the software application ignores the request and does not add a duplicate entry for the particular URL into tag database 200.

As multiple independent users locate and tag web resources, and create web resources themselves, such as quests and collaboration transcripts, the library of tag database 200 captures each web resource along with the valuable human input associated with locating, identifying, and classifying the web resource. In this manner, the present invention banks the human capital invested in searching for and identifying valuable web resources, and leverages that capital for the benefit of subsequent users. Unlike conventional web search engines, which respond to individual search requests as one-time isolated events and provide no historical search records upon which different users can share their search results, the present invention preserves the human effort that goes into identifying valuable web resources relevant to a particular topic, so that other users interested in that topic can immediately benefit from the results of the prior search efforts, and can even build upon it by contributing additional web resources.

Communicator Features

According to a representative embodiment of the present invention, exemplary communicator features facilitate collaboration between users of a web site, providing, for example, conference rooms, message boards, and moderated discussions. The system can record these collaborations in the form of transcripts that can be tagged and stored as with any other web content.

Conference rooms cover contemporaneous conversations and can be public or private. Message boards track ongoing discussions over time among many users, and can include separate discussions (called threads) on subtopics. Moderated discussions typically involve a speaker, a moderator, and an audience. The system enables the speaker to spark discussion by, for example, presenting slides to the audience. The resulting discussions can be contemporaneous or non-contemporaneous, and can be public or private.

Quest Features

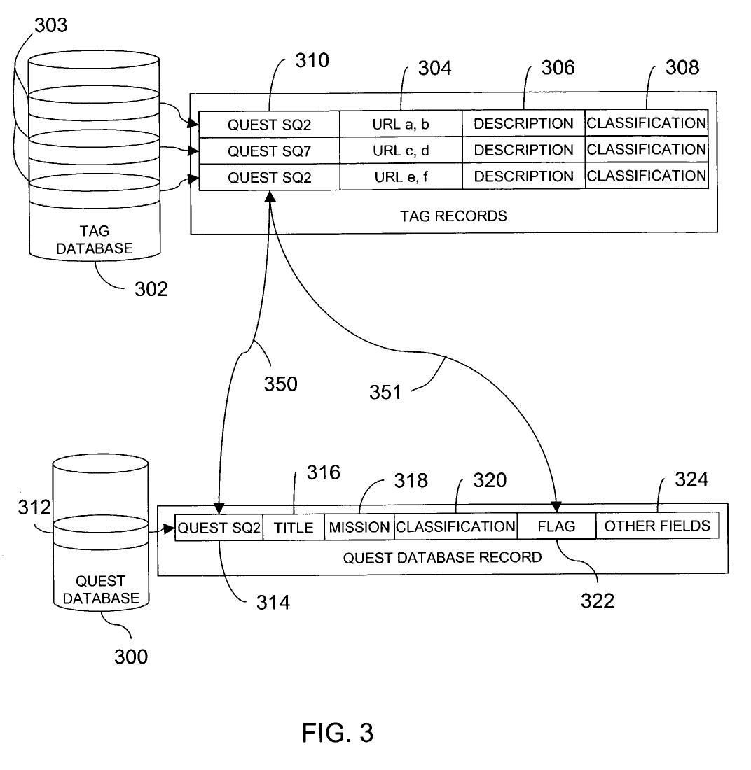

FIGS. 3-5h illustrate a representative embodiment of the Quest Features of the present invention. The core element of the Quest Features is a quest. A quest is made by a creator, administered by a quest administrator, and taken by a questor.

The creator defines the mission (i.e., goal or objective) of the quest, provides instructions for storing the quest in a quest database (or library), and prepares the content to be included in the quest. The creator can also make the quest available to other users (quest administrators), who can access the quest, modify the quest if desired, and administer the quest to a group of questors.

The questor finds the quest in the library; retrieves a copy of the quest; reviews, follows, and responds to the content and instructions prepared by the creator; and prepares appropriate responses, such as essay notes, comments, answers to questions, and bibliographies.

As shown in FIG. 3, the system that implements the Quest Features includes a quest database 300 cross-referenced with a tag database 302, each of which could be stored on server computer 100 (FIG. 1) in a representative embodiment of the present invention.

Quest database 300 contains quest records 312, each including a quest field 314, a title field 316, a mission field 318, a classification field 320, a flag field 322, and other fields 324. Quest field 314 contains a unique identification to distinguish between different quest records 312 in quest database 300. Title field 316 contains an identifying description of the quest provided by the creator. Mission field 318 contains a description of the objective of the quest as defined by the creator. Classification field 320 contains one or more subject categories or key words under which the quest is filed and searchable within quest database 302, and within a library of all tagged web resources (e.g., tag database 200 of FIG. 2A).

Other fields 324 contains supplemental information that a creator provides to enhance the self-guided lesson. For example, other fields 324 could include instructions, guidance, notes, comments, advice, lists of questions to be answered, and lists of items or resources related to the quest (e.g., a “to-do” checklist).

Flag field 322 indicates whether any tagged web resources in tag database 302 have been associated with the quest. These web resources could be, for example, URLs that a questor is instructed to visit while taking the quest. If flag field 322 indicates that no web resources have been associated with the quest, then when a software application launches the quest, the software application does not look up web resources in tag database 302. If, on the other hand, flag field 322 indicates that web resources have been associated with the quest, then the software application looks for the associated web resources in tag database 302. Optionally, instead of, or in addition to, a flag, field 322 could include a list of the tag records with which the quest is associated.

Tag database 302 contains the tag records 303 of web resources that are included in the quests of quest database 300. Each tag record 303 includes a URL field 304, a description field 306, a classification field 308, and a quest field 310. URL field 304, description field 306, and classification field 308 contain information as described above in reference to tag record 201 of tag database 200 (FIG. 2A). Quest field 310 lists the identification of the quest with which a tag record 303 is associated.

Thus, as represented by arrows 350 and 351, when flag field 322 of quest record 312 indicates that web resources have been associated with the quest record 312, the software application that launches the quest looks through tag database 302 to find tag records having the particular quest listed in quest field 310. As shown in the example of FIG. 3, after launching the quest identified as “Quest SQ2” in tag record 312, the software application would retrieve two of the three tag records 303 shown (i.e., those with “Quest SQ2” in quest field 310). The software application would then display quest SQ2 (from information in quest record 312) along with its associated web resources (e.g., URL a, b and URL e, f) from the tag records 303 that are marked “SQ2.”

Tag database 200 of FIG. 2A and tag database 302 of FIG. 3 could be the same database. In an embodiment of the present invention, however, tag database 200 and tag database 302 are separate databases. Tag database 200 stores tag records for all web resources that have been identified and/or created by users, such as web pages, quests, and collaboration transcripts. The tag records 201 contained in tag database 200 are preferably unique, with no two entries having the same URL 204. In contrast to tag database 200, tag database 302 preferably includes only web resources associated with quests. In addition, tag database 302 preferably allows entries having the same URLs 304, in which case each different entry corresponds to a different quest and (most likely) has unique information stored in description field 306 and classification field 308.

In an embodiment of the present invention, in the context of creating quests, the tag database 200 of FIG. 2A serves as a valuable archive of search efforts. Specifically, when a user creates a quest and identifies web resources to associate with the quest, a software application operating on remote server computer 100 (FIG. 1) copies the web resources to tag database 200. In this manner, the present invention takes advantage of the fact that a user has located a web resource that the user feels has some value. Recognizing that what one user finds valuable other users often do also, the present invention stores the web resource in tag database 200 for searchable access by all users. In addition, as stated above, the quest itself is stored in tag database 200 as a resource to be shared with all other users.

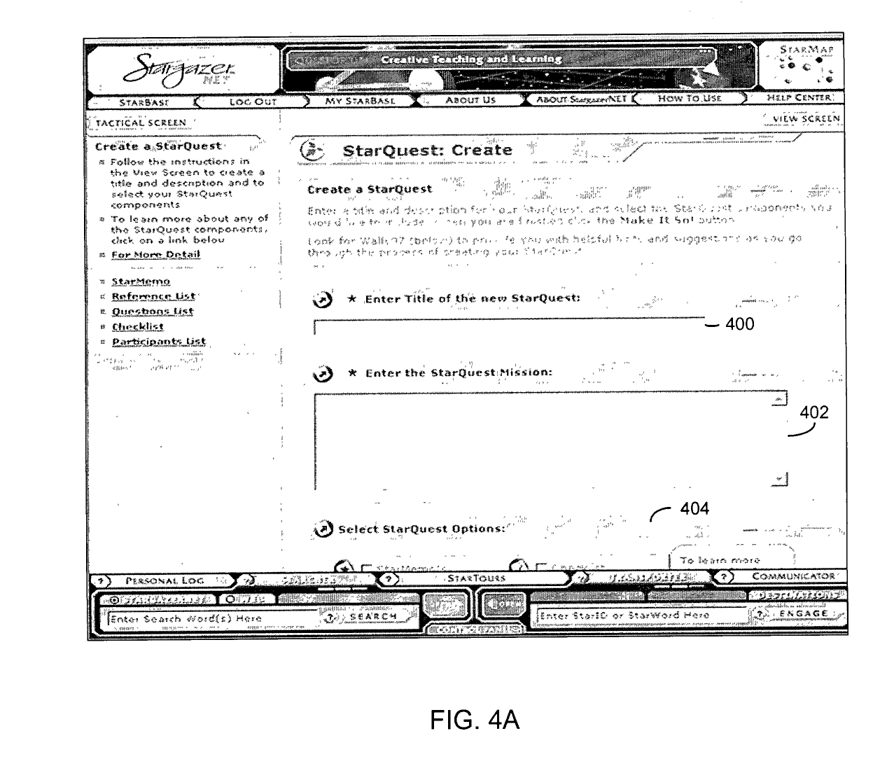

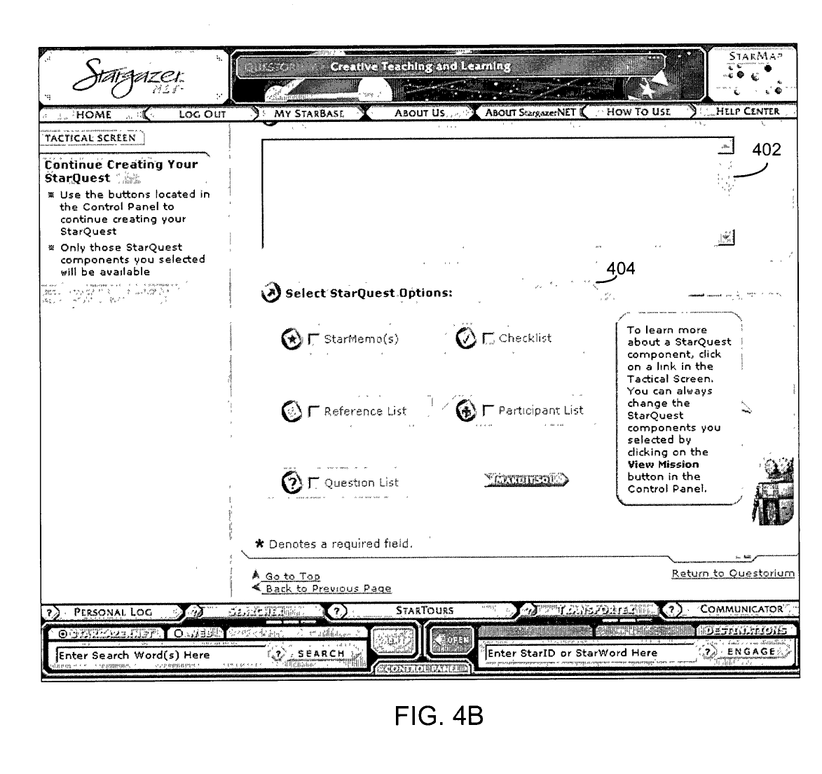

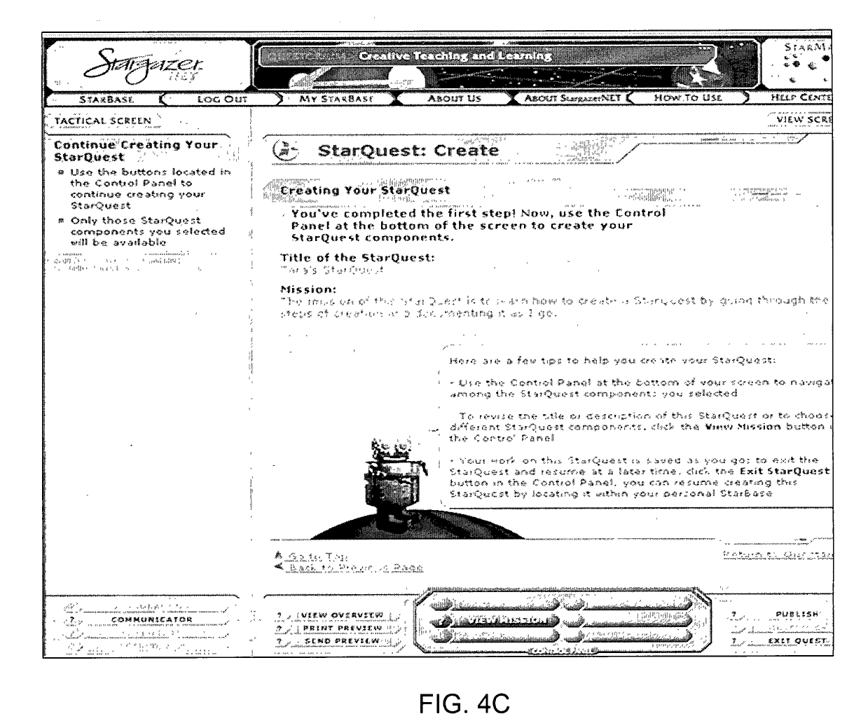

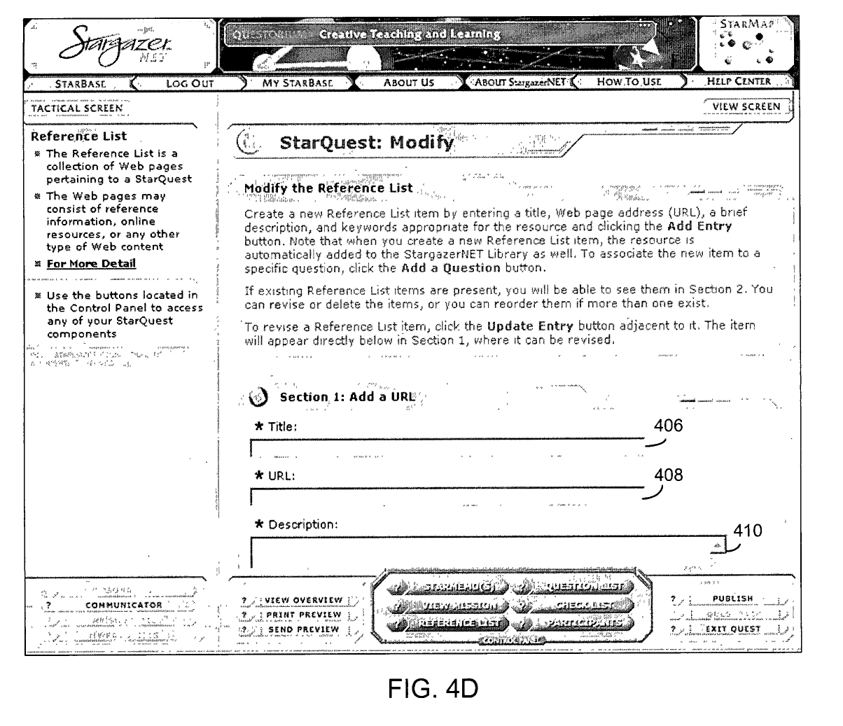

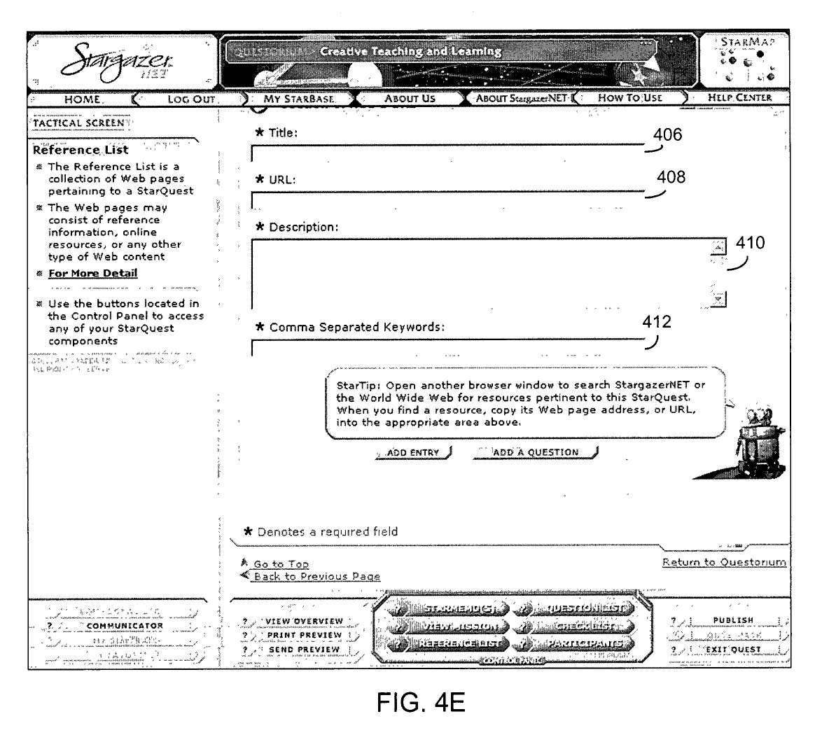

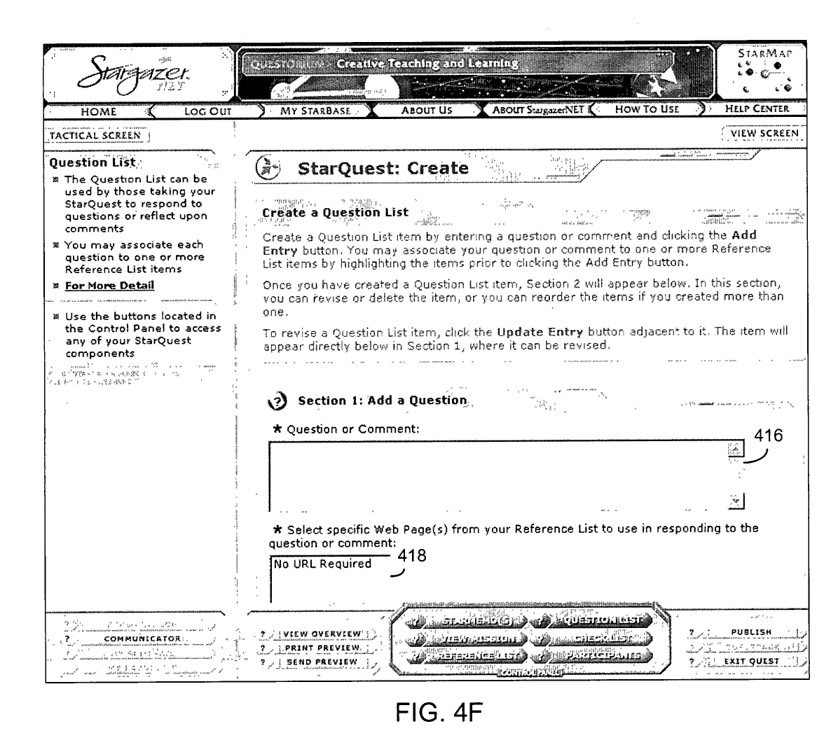

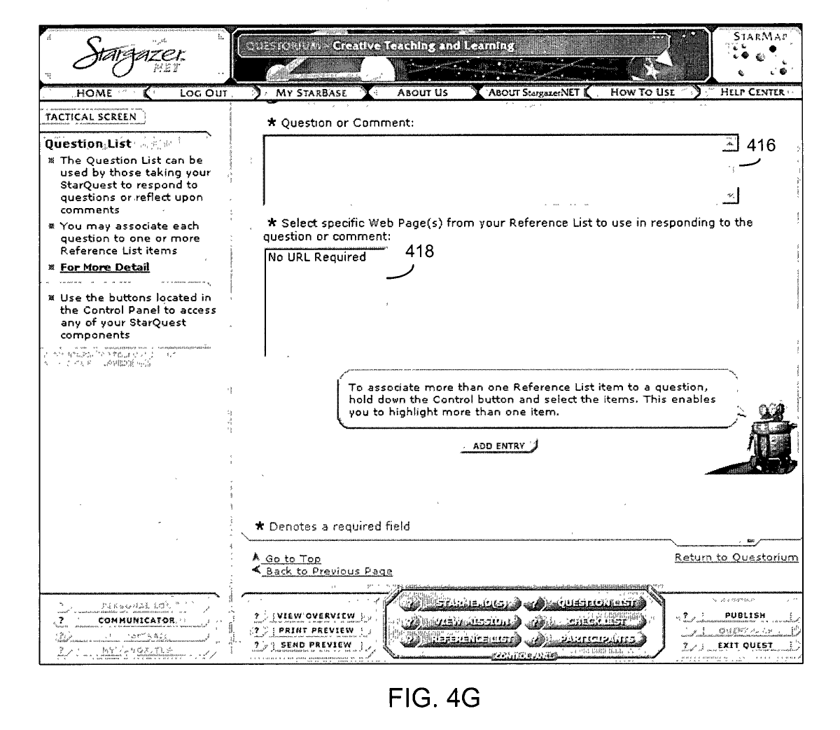

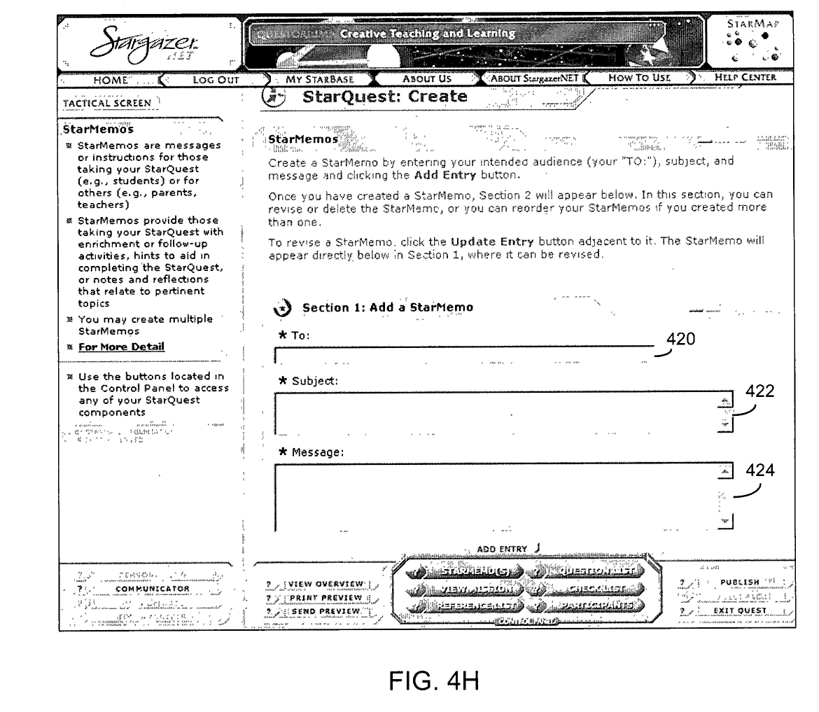

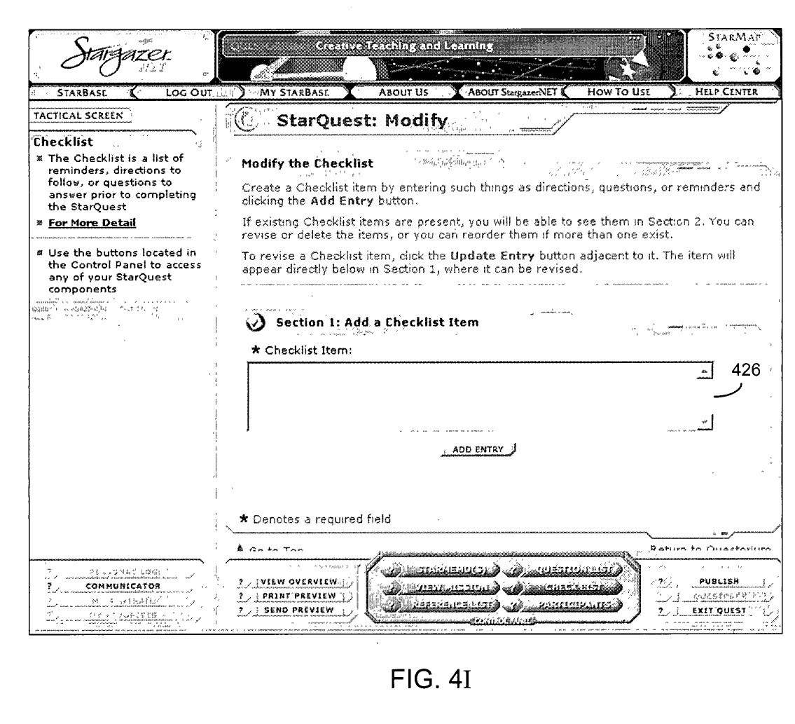

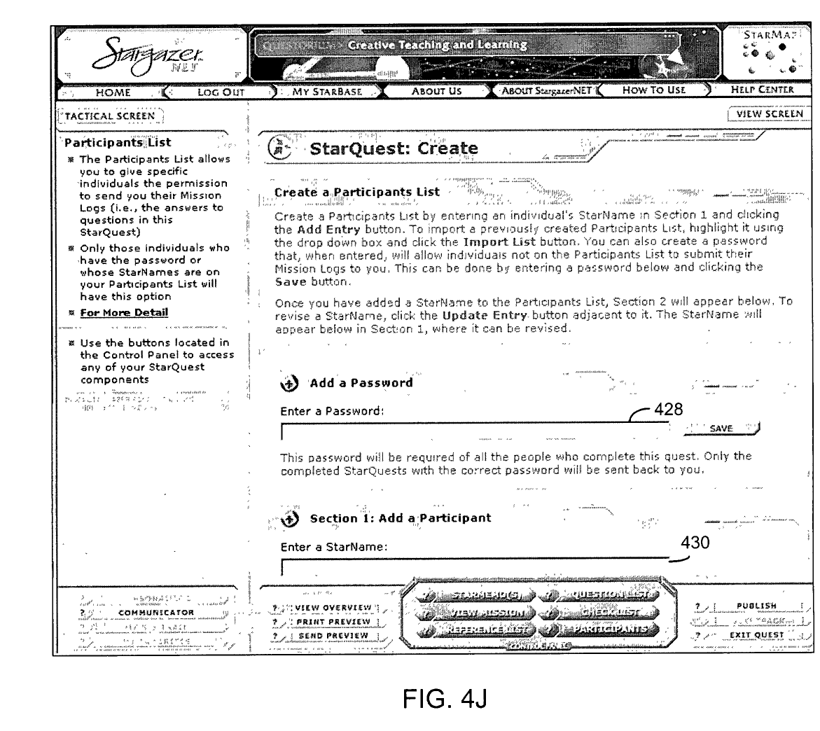

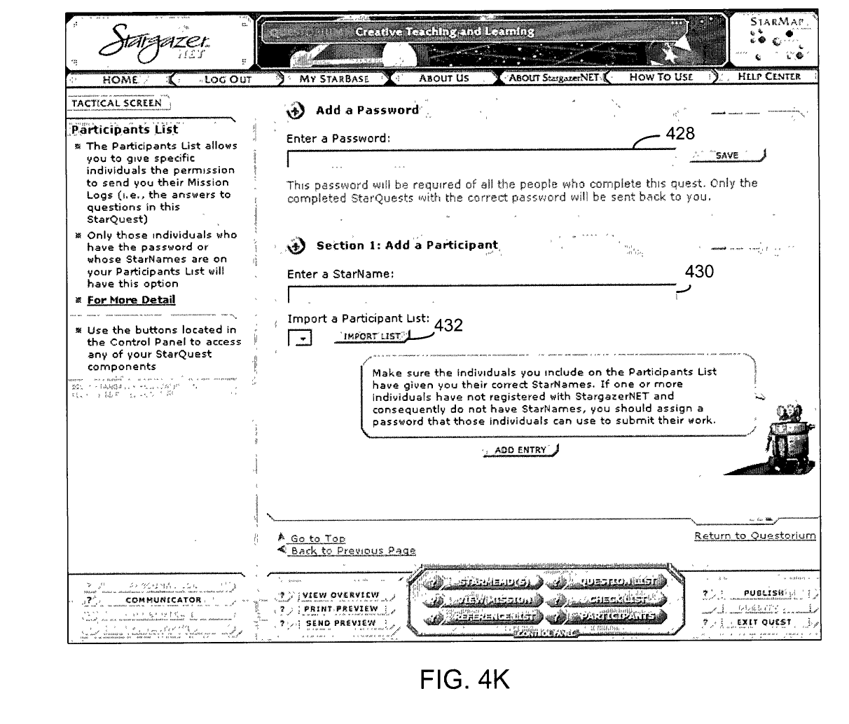

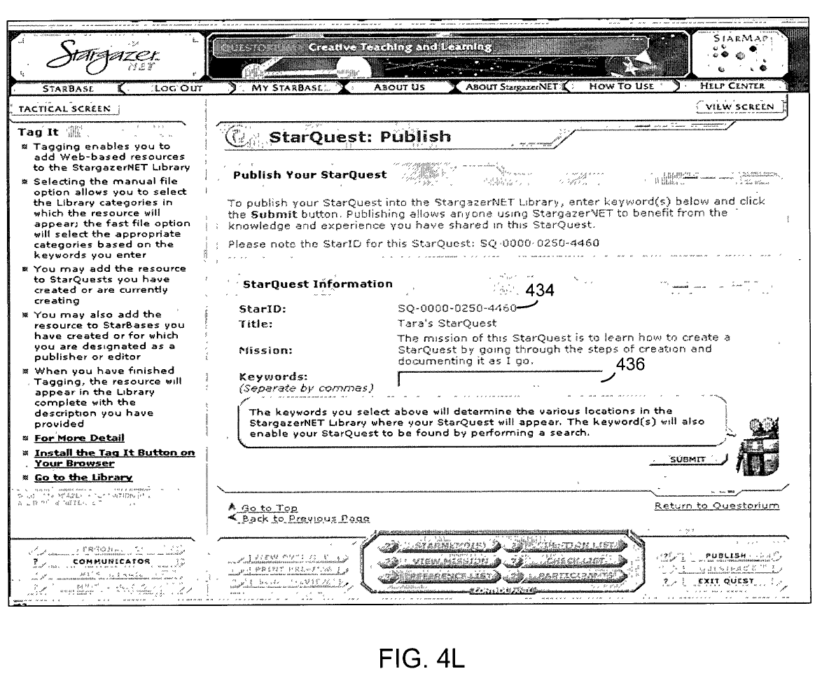

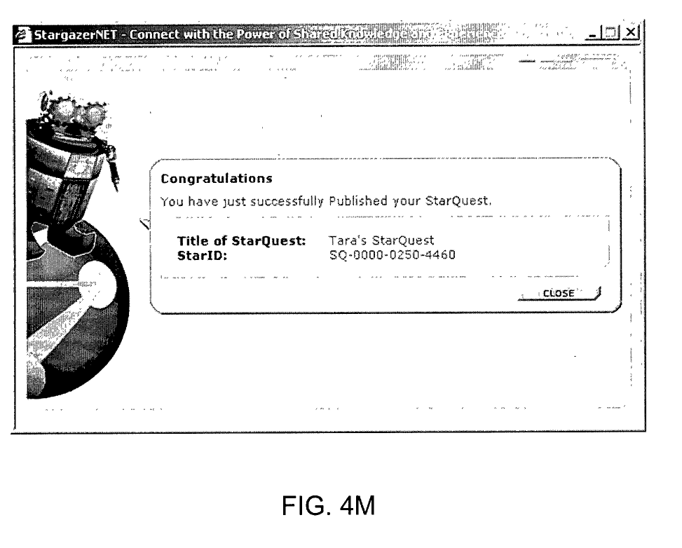

FIGS. 4A to 4M illustrate representative GUIs shown to a user (i.e., a creator) engaged in the process of creating a quest. FIGS. 4A and 4B illustrate an exemplary GUI, scrolled to the top and bottom, respectively, for defining a quest. As shown, this first step involves entering a title 400 and a mission 402, and selecting components 404 to include in the quest, such as a memo, a reference list, a question list, a checklist, and a participant list. With reference to FIG. 3, the data entered into title 400 populates the title field 316 of quest record 312. The data entered into mission 402 populates the mission field 318 of quest record 312. The selected components 404 dictate which additional data entry GUIs are displayed to the user (discussed below). In this example, all components 404 are chosen. After completing fields 400, 402, and 404 of FIGS. 4A and 4B, a confirmation page is displayed to the user showing the title and mission of the newly created quest, and providing instructions for creating the selected components of the quest, as shown in FIG. 4C.

FIGS. 4D and 4E show an exemplary GUI, scrolled to the top and bottom, respectively, in which the quest creator enters one or more web resources to associate with the quest. This reference list of URLs specifies, for example, the location of ERs that are relevant to one or more questions to be incorporated in the quest. As shown, the user enters the URL 408 of the web resource, which populates the URL field 304 of the tag record 303. The user also enters key words 412 to associate with the web resource, which populate the classification field 308 of the tag record 303. Optionally, the user can also enter a description 410, which populates the description field 306 of a tag record 303 (FIG. 3). The user can also enter a title 406 for the web reference. A user repeats this data entry process for as many web resources as desired.

FIGS. 4F and 4G show an exemplary GUI, scrolled to the top and bottom, respectively, in which the quest creator enters a question list to associate with the quest. As shown, the creator enters one or more questions 416 relevant to the quest mission, which populate the other fields 324 of the quest record 312 (FIG. 3). It should be understood, however, that these questions are optional and are not a necessary element of a quest. Each question may also be associated, in field 418, with a URL specified on the reference list created in the second step. This association is also recorded in other fields 324 of the quest record 312.

FIG. 4H shows an exemplary GUI for entering a memo, which is a message or instruction to a user taking the quest (e.g., students) or to other users (e.g., parents and teachers of a student). Memos are intended to enable quest creators to provide quest takers (or other users) with enrichment and follow-up activities, hints to aid in completing the quest, or notes and reflections that relate to pertinent topics. It should be understood, however, that these memos are optional and are not a necessary element of a quest. As shown, the quest creator enters the intended audience 420 of the memo, the subject 422 of the memo, and the message 424 of the memo. This data is recorded in other fields 324 of the quest record 312.

FIG. 41 shows an exemplary GUI for entering a list of checklist items 426, including, for example, ancillary questions, directions, hints, recommendations, reminders, and a similar or related quest. As an example, the checklist could be a list of reminders, directions to follow, or questions to answer prior to completing a quest. It should be understood, however, that this checklist is optional and is not a necessary element of a quest. This checklist is recorded in other fields 324 of the quest record 312.

As a further embodiment of the present invention, FIGS. 4J and 4K illustrate an exemplary GUI, scrolled to the top and bottom, respectively, for entering a participant list, which enables a quest creator to give designated quest takers permission to return quest results (e.g., a mission log as discussed below) to the quest creator. The quest creator designates quest takers by establishing a password and/or by creating a participant list. As shown, the quest creator can enter a password 428 that the designated quest takers must provide to send quest results (e.g., answers to quest questions) back to the quest creator after completing the quest. The quest creator separately communicates the password to the designated quest takers. Alternatively, the quest creator can enter the names 430 of the designated quest takers, in which case only the quest results from quest takers having the listed names are returned to the quest taker. Optionally, the quest creator can also import a list of participants by clicking import button 432.

A further embodiment of the present invention enables a quest creator to limit access to a quest to designated quest takers. Access would be controlled using password 428 or the names 430 of the designated quest takers. In this case, the quest takers must enter password 428 to take a quest. Alternatively, the quest creator enters the names 430 of the designated quest takers, in which case only the named quest takers are permitted to take the quest. Optionally, the quest creator can also import a list of participants by clicking import button 432.

After the quest has been created and all selected components defined, a publish page is presented to the quest creator as shown in FIG. 4L. This page lists the title and mission of the quest as defined earlier (see FIGS. 4A and 4B) by the quest creator. The page also lists the unique identification 434 assigned to the quest, which corresponds to quest field 314 of quest record 312 (FIG. 3). To publish the quest to the library (e.g., quest database 300 of FIG. 3), the quest creator defines one or more key words 436 to associate with the quest. The data entered into key words 436 populates the classification field 320 of quest record 312. The key words determine the classifications under which the quest is stored for search purposes.

Finally, after the quest creator defines the key words, a page confirming the publication of the quest is displayed to the quest creator, as shown in FIG. 4M. This exemplary page lists the title and unique identification of the quest.

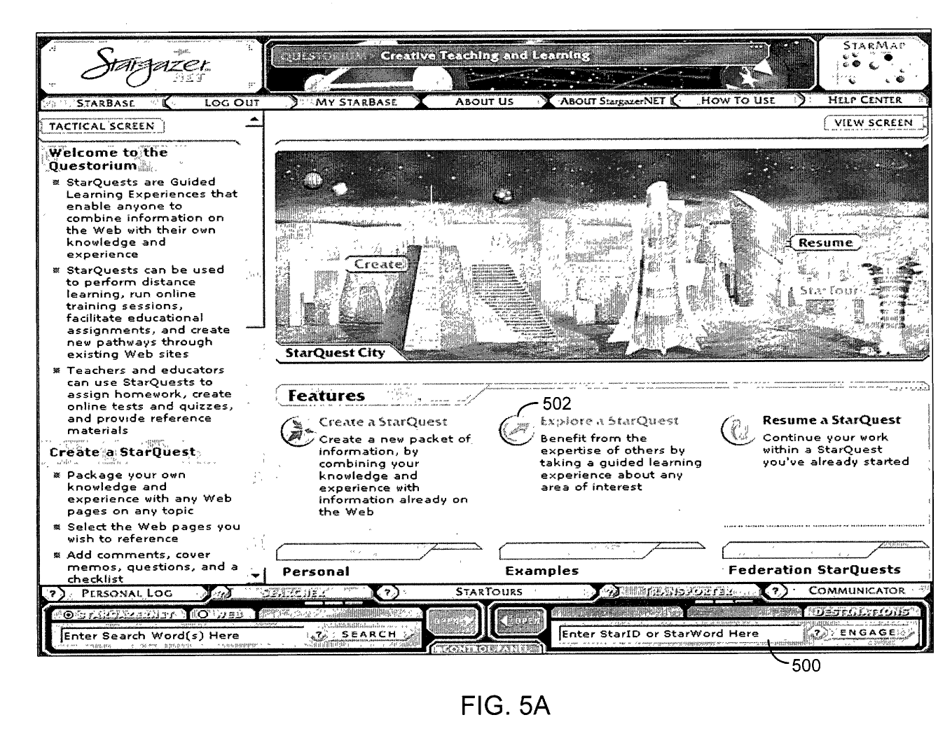

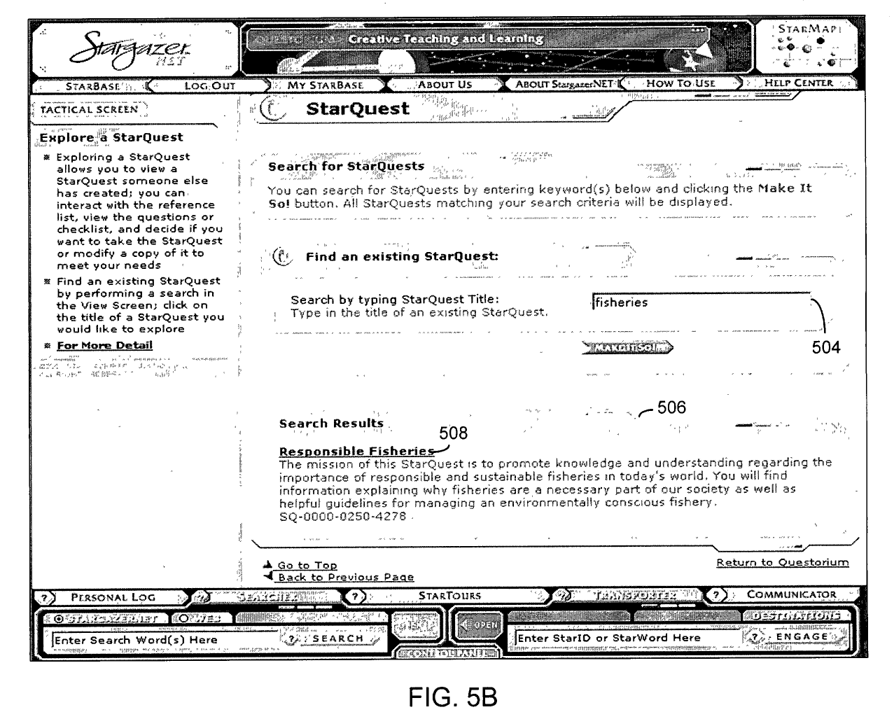

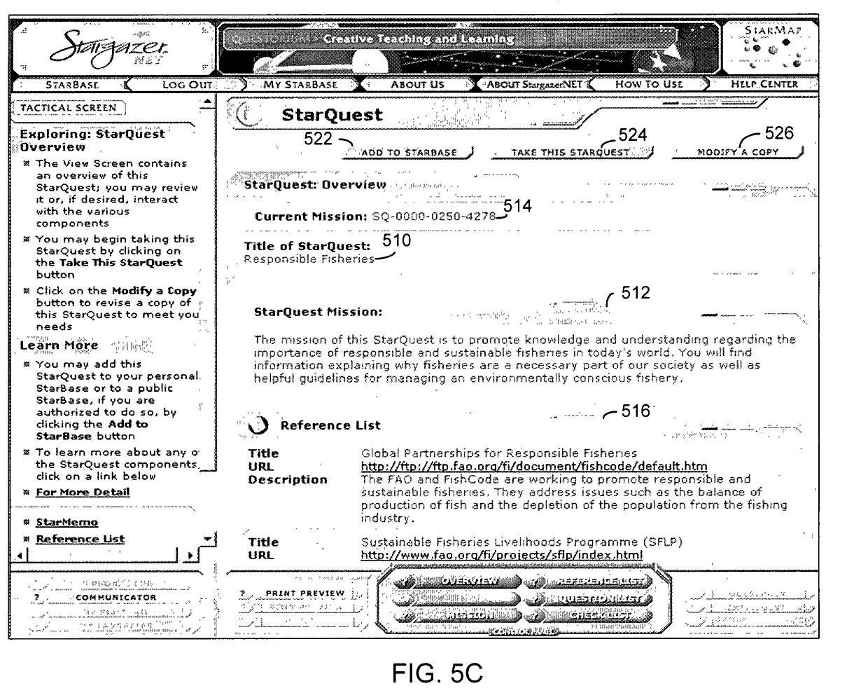

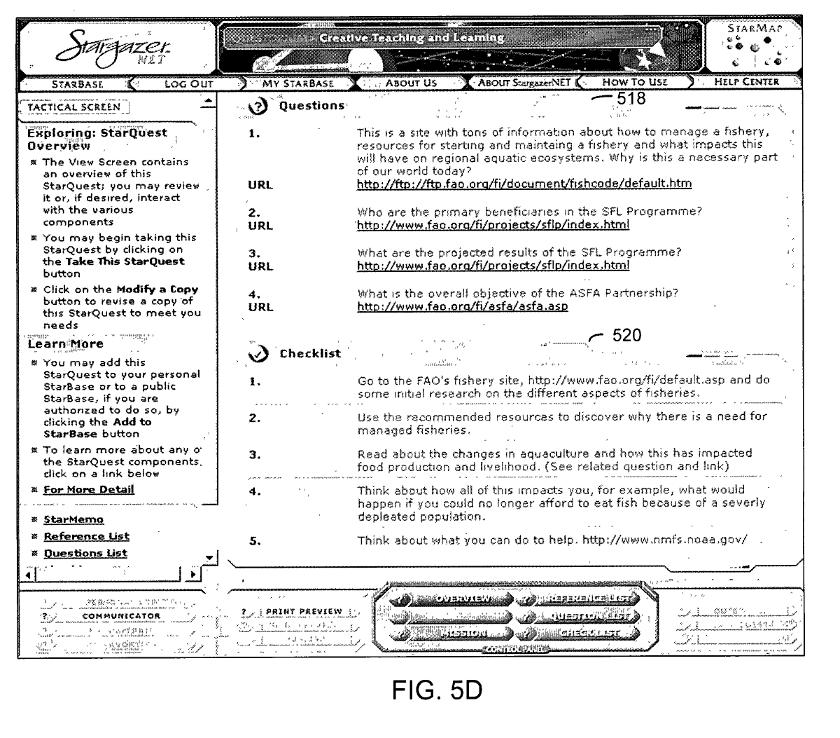

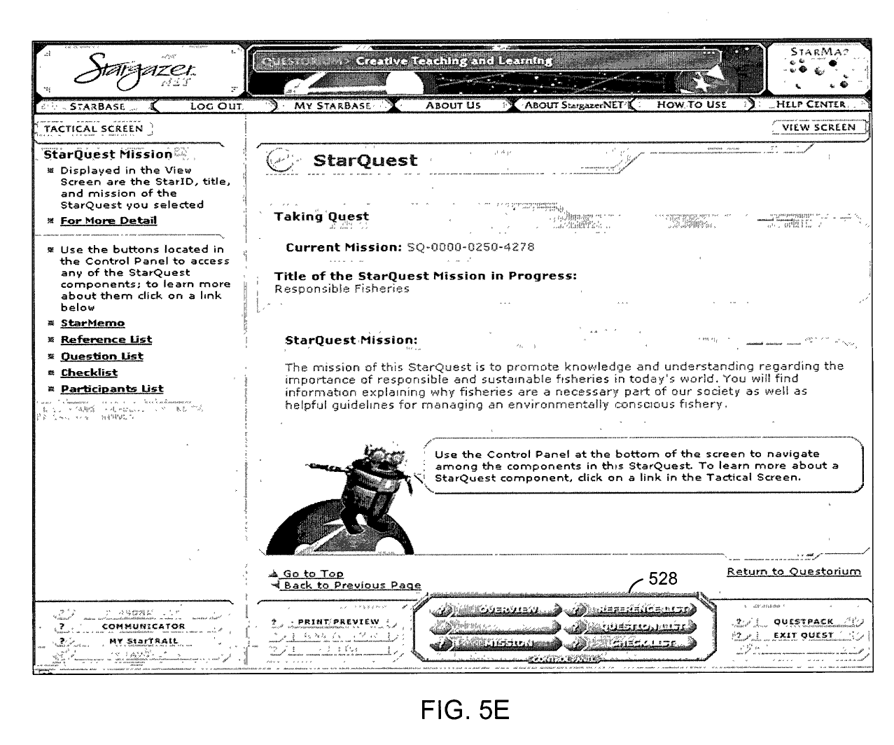

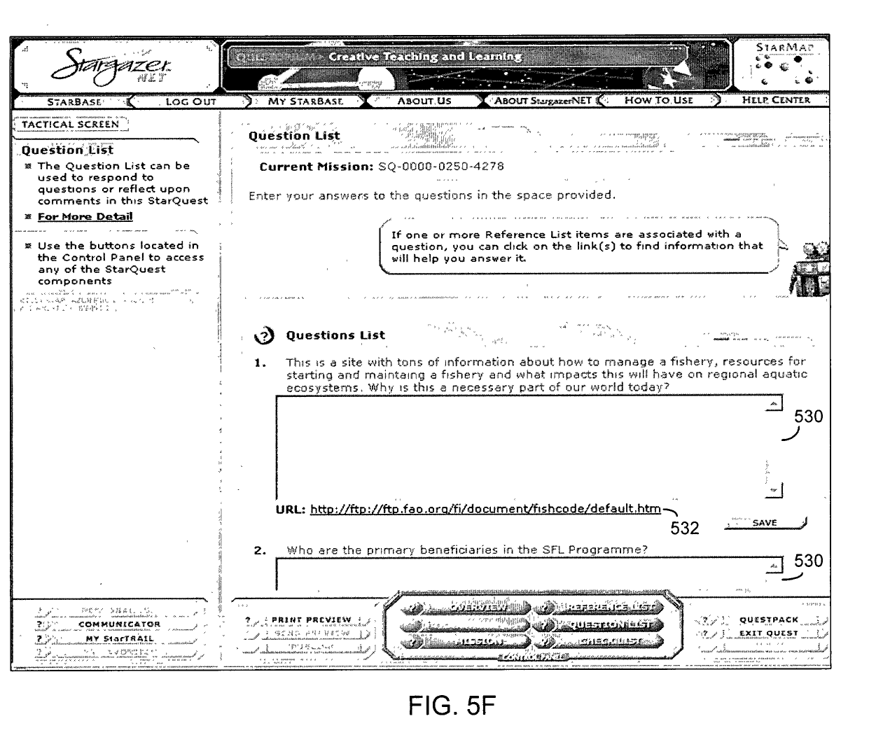

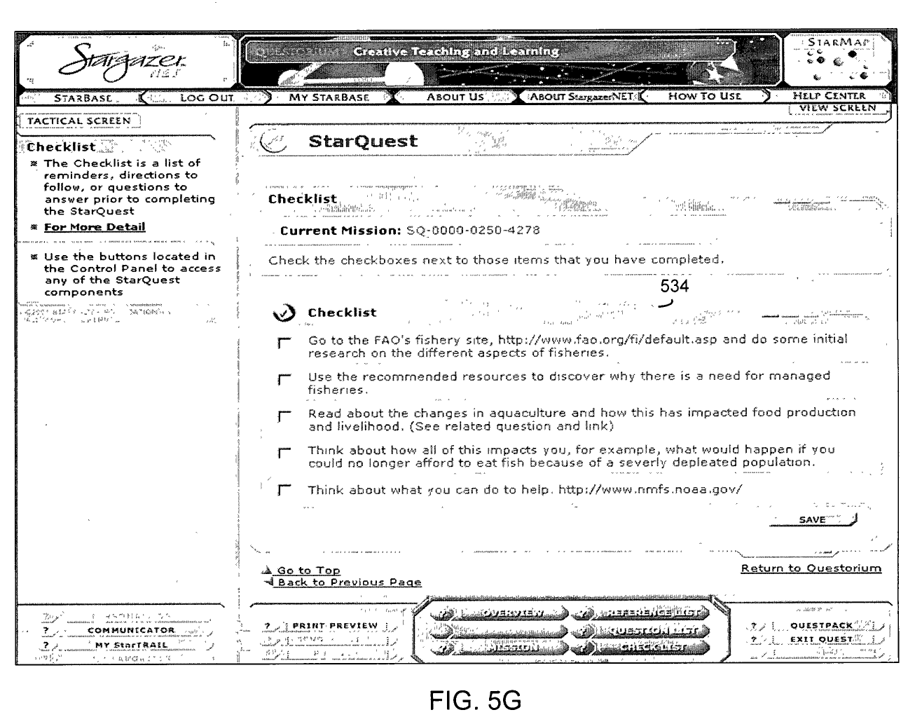

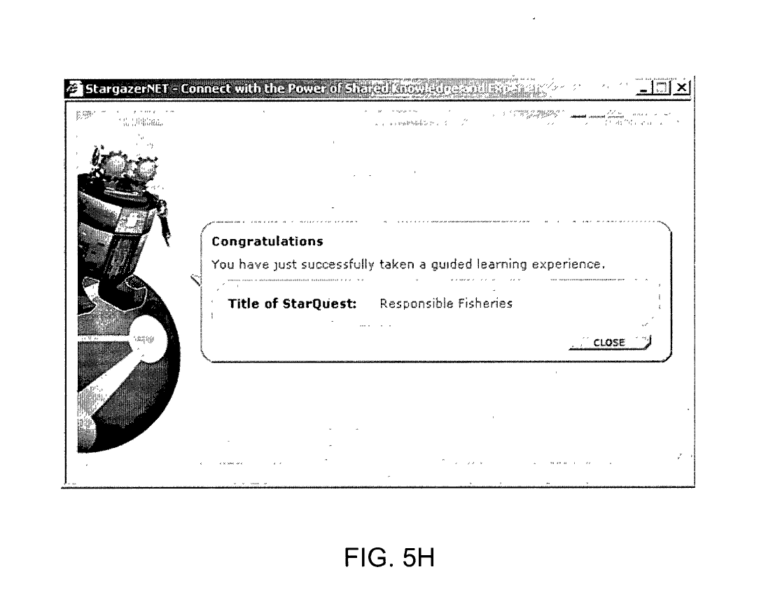

FIGS. 5A to 5H illustrate representative GUIs shown to a user (i.e., a questor) engaged in the process of selecting and participating in a quest. As shown in FIG. 5A, the first step requires the questor to indicate which quest the user would like to take. If the user knows the unique identification of the desired quest, the user enters the quest identification in field 500. Referring to FIG. 3, this quest identification corresponds to the quest field 314 of a quest record 312.

Alternatively, by clicking the explore link 502, the user can search quest database 300 for a particular quest in which the user is interested. In response to clicking link 502, a search page is displayed as shown in FIG. 5B. A search can cover one or more of the fields of quest database 300 (FIG. 3). However, in the example of FIG. 5B, a search for the term entered in search field 504 looks in title field 316. In this example, the questor has entered the term “fisheries” in search field 504.

In response to the questor's search request, search results 506 are listed as shown in FIG. 5B. In this example, search results 506 list all of the quests having the term “fisheries” in the title. The questor selects the desired quest by clicking on the title link 508 of the quest.

With the particular quest chosen, in the next step, as shown in FIG. 5C and 5D, pages are displayed listing the chosen quest's title 510, unique identification 514, and mission statement 512 (corresponding to title field 316, quest field 314, and mission field 318, respectively, of FIG. 3). The pages also include the reference list 516 associated with the quest (corresponding to the tag records 303 listing the identification of the quest in quest field 310 of FIG. 3), the questions 518 associated with the quest (corresponding to other fields 324 of FIG. 3), and the checklist 520 associated with the quest (also corresponding to other fields of FIG. 3). The pages also provide several options to the questor, including adding the quest to a StarBase 522, taking the quest 524, or modifying a copy of the quest 526 (in effect, creating a new quest).

If the questor chooses to take the quest (e.g., clicks button 524), then, as shown in FIG. 5E, a page is displayed to the user confirming the taking of the quest and providing instructions for navigating among the components of the quest, using buttons 528.

If the questor chooses to view the question list, then, as shown in FIG. 5F, a page is displayed that lists the questions associated with the quest, and the references associated (if any) with each question. The questions are retrieved from the other fields 324 of the quest record 312 (FIG. 3). The questor can answer the questions by entering data in the answer fields 530. The questor can also view a web resource associated with a question by clicking on a link 532 to the web resource.

According to an embodiment of the invention, in completing the quest, the questor produces a mission log, which includes, for example, reports, question answers, and tags. The reports include information such as general commentary, essay, notes, explanations, and other responses appropriate for a particular quest. The question answers include answers to any specific questions posed as a part of the quest. The tags correspond to additional web pages that the questor accessed (in addition to the references listed in the quest) in completing the quest.

As shown in FIG. 5G, before completing the quest, the quest's checklist 534 (if any) is displayed along with a checkbox for each item on the checklist. The checklist is retrieved from the other fields 324 of the quest record 312 (FIG. 3).

Finally, as shown in the example of FIG. 5H, after the questor completes the quest, a confirmation page is displayed to the questor verifying the completion of the quest.

In an embodiment of the present invention, the Quest Features provide a rating function that allows questors and quest administrators to rate the quality of a particular quest. The output of the rating function (i.e., a rating) enables a quest creator or quest administrator to choose the best quest from among a group of quests dealing with the same subject.

Based on user feedback, the rating function measures criteria such as the quality of content within a quest, the quantity of content within a quest, the number of quest administrators that have used a quest, the number of questors that have taken the quest, and the number of quest administrators and questors that have added content to the quest. The rating function could also consider the reputation and integrity of the entities providing the information resources listed in a quest. For example, a quest that directs questors to university or government web sites might be favored over a quest that directs questors to privately sponsored web sites.

According to an embodiment of the present invention, a questor selects and participates in a quest through an online GUI, as illustrated in FIGS. 5A-5H. For example, with reference to FIG. 1, a quest taker using a local client computer 102 could communicate with remote server computer 100 over an online connection through global computer network 104. Cooperative software (e.g., network browsing software) provisioned on local client computer 116 would interface with application software on remote server computer 100 to present the GUIs depicted in FIGS. 5A-5H.

As an alternative embodiment, a questor selects and engages in a quest by downloading a quest and manipulating the quest offline using desktop software, such as word processing software. Taking the quest offline avoids the high costs of online computer access. As an example, a quest taker could download quest files from remote server computer 100 to local client computer 102. The quest files would preferably include Rich Text Format (RTF) files and Hypertext Markup Language (HTML) files. The HTML files would include one or more web screen pages corresponding to URLs listed in the quest. The RTF files would include, for example, the lesson defined by the quest creator, listing such items as questions and tasks the questor must complete. The RTF files would also include links to the HTML files. By clicking through the links, a questor could display the web screens related to the quest.

The downloaded RTF and HTML files are compatible with readily available commercial desktop software, such as word processing and web browsing software, respectively. Thus, instead of browsing online from a quest to its various related URLs, a questor can complete the quest offline using word processing software. The word processing software would provide links that would launch the HTML files using the browsing software.

In addition to saving on online computer connection costs, completing the quest using a word processor carries advantages related to the expanded features available from word processing software. For example, with the word processing software, the questor has access to grammar and spell-checking features that would improve the questor's end product.

Optionally, instead of including offline links to downloaded HTML files, the RTF files could include online links. In this case, the questor could review and fill out the quest using a word processor, and then click through the links and establish a network connection only when the questor is ready to review the related web pages.

Clusters

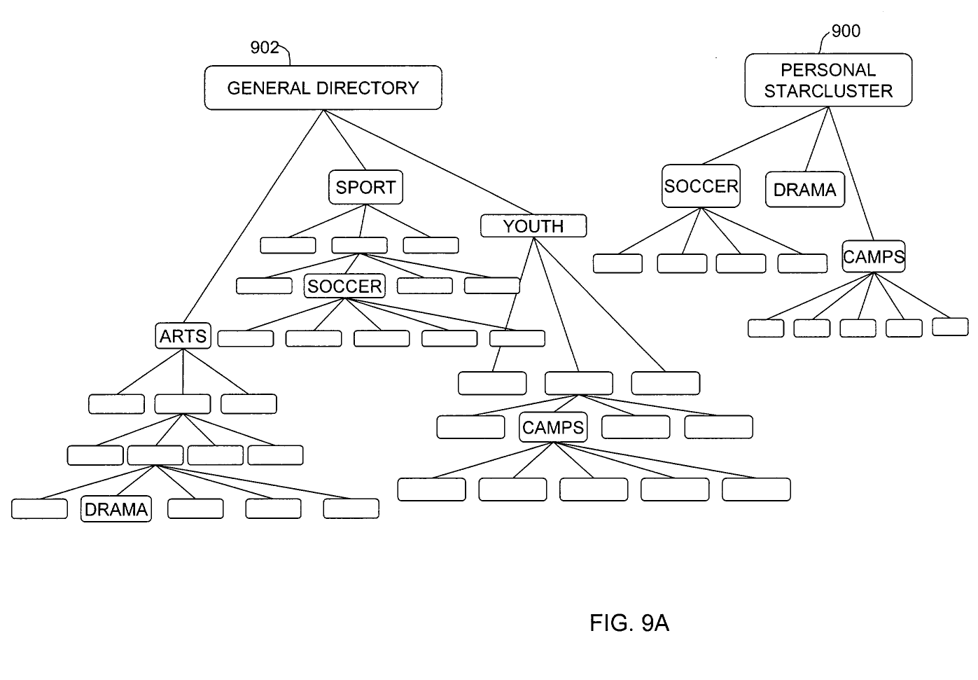

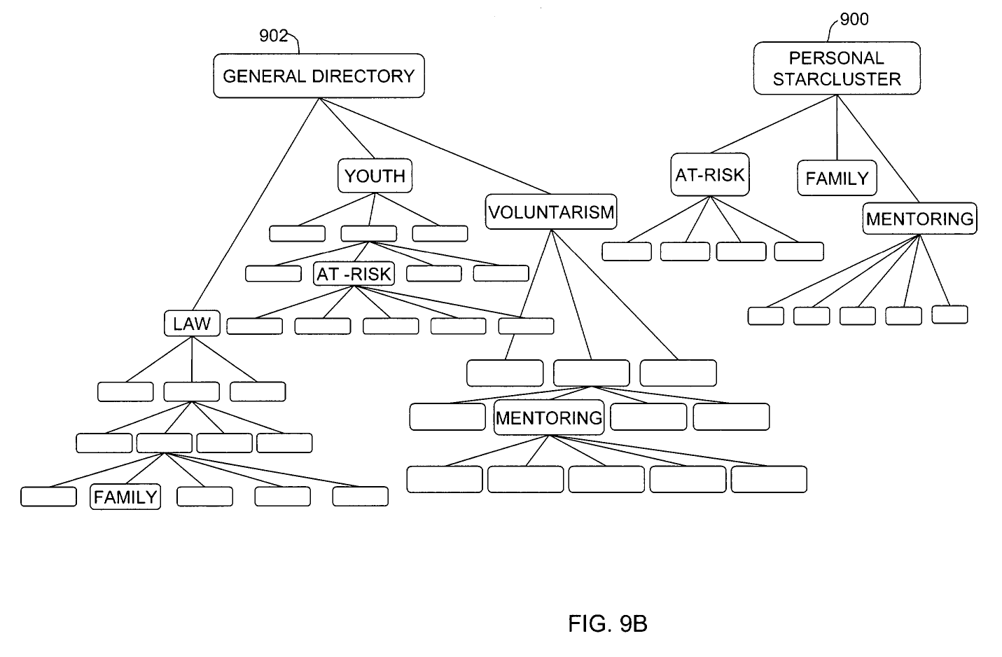

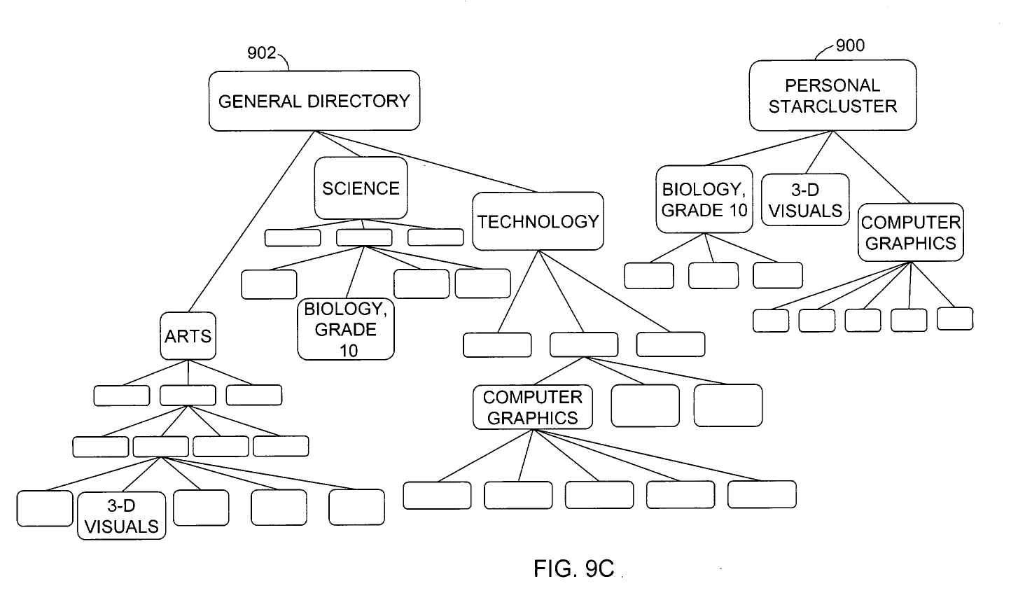

According to an embodiment of the present invention, FIGS. 9A-9C illustrate a unique taxonomy based on clusters. In essence, these clusters (or “StarClusters”) are customized, automatically updated groupings of web content. Starting with a general directory of information, a user can create specialized portals, organizational libraries, and tailored categories of documents, web pages, experiences, and databases to meet individual or organizational needs.

In choosing and associating web content within a StarCluster, a user creates a new personal directory and portal for specific categories of interest. The StarCluster exists apart from the general directory (which remains available) and can be public, private, or semi-private, as designated by the creator.

A public StarCluster is freely accessible by other users. In addition to the creator, other users can view the StarCluster and access its information resources. In this manner, an administrator of a web site can give outside organizations the privilege of building and maintaining personal directories (StarClusters) through the administrator's web site and based on the administrator's own general directory.

With a private StarCluster, the creator limits access to the directory to herself or a group of users to which the creator has given access.

Finally, with a semi-private StarCluster, the creator allows other users to see the categories available in the StarCluster, but not the individual information resources stored in those categories (which are password protected). If a user is interested in viewing the resources, the present invention provides means by which a user can query the creator for full access to the StarCluster, including the information resources.

FIGS. 9A-9C illustrate StarClusters 900 for “Drama and Soccer Camps,” “Legal Background and Mentoring Opportunities with At-risk Youth,” and “3-D Graphics for 10^{th} Grade Biology Classes,” respectively. In each case, the particular StarCluster 900 associates specific information desired by the user who created it. The user therefore has an easily understandable and manageable body of content, especially in comparison to the general directory 902, which would require drilling down through menus or advanced search techniques to find desired content.

Clusters for individual or organizational directories provide a uniquely flexible taxonomy. For example, clusters are dynamically updated because they associate categories of dynamically updated information (i.e., StarTags), rather than individual, static web page bookmarks. After a user has created a cluster, the system automatically updates the cluster with additional relevant content that is later added to the general directory. The system matches existing clusters with new content based on assigned categories. Thus, the system of the present invention constantly updates a user's library of information in the StarCluster at the category level.

Another example of this flexibility is the ability of the present invention to prompt a creator of a cluster to add information resources to a cluster. For instance, if a new category is added by another user, which may be relevant to categories of an existing cluster, the present invention can ask the creator of the existing cluster if she wants to add the new category to the existing cluster. Similarly, if an information resource is added, such as a new chat room, the present invention can suggest to the creator of an existing cluster that the new information resource be added to the cluster.

As another example of flexibility, the StarClusters enable users to create a taxonomy within a taxonomy. In this manner, one user can use another user's taxonomy (StarCluster) as a basis for building his own personal directory. This approach greatly improves the efficiency of building individual StarClusters.

Navigation Tool

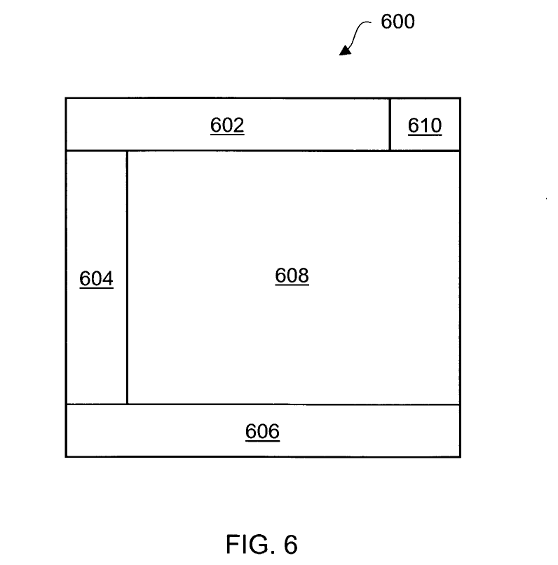

An embodiment of the present invention includes the provision of a novel GUI navigation tool, as illustrated in FIG. 6. Unlike conventional user interfaces, this navigation tool includes a view screen surrounded by persistent view areas that provide header information, control information, user instructions, and location indicators. In contrast to the present invention, conventional means of navigation on the web typically involve dividing a web page into three components: a header positioned across the top of the page; a vertical area on the left side of the page typically referred to as a left navigational bar; and the remaining portion of the page under the header and to the right of the left navigational bar where content is provided. Using “frames” technology, the pages of conventional web sites can be configured such that a user can scroll through each of the three areas independently (typically, however, the header does not scroll).

As illustrated in FIG. 6, a representative embodiment of the navigation tool of the present invention includes a web page 600 divided into five distinct areas: header 602, tactical area 604, control panel area 606, view area 608, and location indicator area 610.

Although FIG. 6 shows areas 602, 604, 606, 608, and 610 in certain positions on page 600, one of ordinary skill in the art would appreciate that these five distinct areas could be arranged differently and still provide the benefits described below. For example, tactical area 604 could be on the right side of view area 608, instead of the left. Indeed, the positioning of the areas of page 600 is secondary to their functional relationships.

View area 608 is the central portion of the web page through which a user views and enters information, and performs other activities supported by the web site. The remaining areas of the web site change according to the activities occurring in view area 608, as described below.

Header 602 is positioned at the top of the web page. In an embodiment of the present invention, however, unlike the header of a traditional web site, header 602 does not span the entire width of the screen. Instead, a portion of this top area of the page is reserved for location indicator area 610, which is sometimes referred to herein as “StarMap.” Header 602 can include general function buttons such as “login,” “search,” and “about us,” and can provide general information about the web site, for example, information about the sponsor of the web site. Location indicator area 610 is a click-through button for accessing further navigation tools, which are discussed in more detail below.

Tactical area 604 provides an ongoing user tutorial, displaying instructions related to the activities occurring in view area 608. Thus, a user always has tactical instructions in view to assist in completing tasks on the web site.

Control panel area 606 also changes in accordance with the activities occurring in view area 608. Control panel area 606 presents control buttons that execute activities in view area 608. The control buttons also initiate the display of instructions in tactical area 604. For example, control panel area 606 may provide an “edit” control button that, when clicked-through, enables a user to edit content in view area 608 and, at the same time, initiates the display of editing instructions in tactical area 604.

In this manner, control panel area 606 cooperates with tactical area 604 and view area 608 to provide a persistent navigation tool through the web site. The control buttons available in control panel area 606 change as the activities of view area 608 change. In turn, the instructions of tactical area 604 change as well. Thus, a user can always view available functions and corresponding instructions when engaged in an activity in view area 608. Unlike conventional web sites, in which a user often must search for function buttons buried throughout the web pages, a user of the present invention can always find and activate the function buttons of control panel area 606, regardless of how the user manipulates view area 608. Consequently, the navigation features of the present invention allow easy navigation by young children and seniors who may not be as experienced with the cumbersome conventional navigation tools.

In an embodiment of the present invention, the control buttons of control panel area 606 include two portions: a question-mark portion and a main portion. Clicking through the question-mark portion changes the instructions provided in tactical area 604 to, for example, provide more detailed instructions on what function that button executes. In this manner, a user can look ahead into the instructions to determine the effect that clicking through a particular control button will have on activities occurring in view area 608. Clicking through the main portion changes both the instructions of tactical area 604 and the actual activity occurring in view area 608.

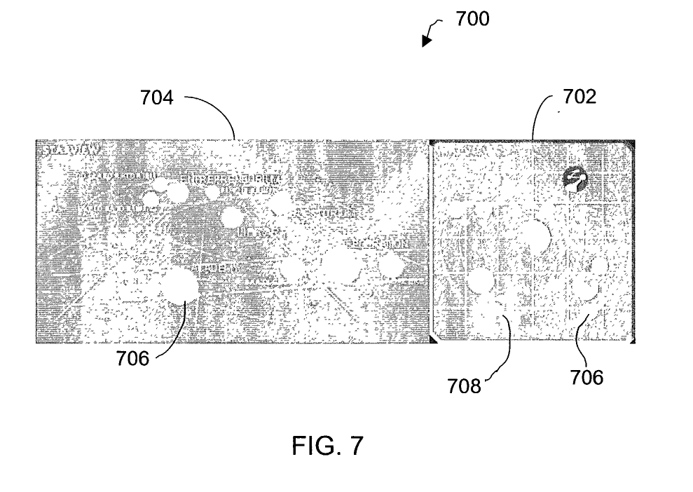

Location indicator area 610 is a click-through button providing further navigation tools of the present invention. Clicking through this StarMap button opens a separate window 700, as shown in FIG. 7. Window 700 includes a two-dimensional (2-D) map view 702 and a three-dimensional (3-D) planetary view 704. Map view 702 is a top-down two-dimensional view of function icons 706 available on the web site. In an embodiment of the present invention, as shown in FIG. 7, icons 706 are planets of a solar system, with each planet representing a different function. A location marker 708 (depicted as a spaceship in this example) indicates the current function a user is executing, effectively serving as a “you are here” marker. In an embodiment of the present invention, this location marker 708 is a spaceship positioned next to an icon corresponding to the current function that a user is executing.

In an alternative embodiment of the present invention, map view 702 is replicated in location indicator area 610 of FIG. 6. In this manner, a user can always view the information of map view 702 while interacting with the web site, and without necessarily having to click-through location indicator area 610.

Returning to FIG. 7, 3-D planetary view 704 is a three-dimensional representation of icons 706 shown in map view 702. In an embodiment of the present invention, icons 706 are planets. The display in 3-D planetary view 704 changes according to which function a user is currently executing. 3-D planetary view 704 reorients icons 706 to reflect the view from the particular icon, or planet, with which the user is currently working. For example, the 3-D planetary view 704 of FIG. 7 reflects a view from the perspective of the “Academy” icon, which corresponds to the Academy function currently being executed. Alternatively, although not shown in FIG. 7, 3-D planetary view 704 could also include an icon showing the user's location, such as icon 708 (e.g., a spaceship) shown in map view 702. Also, alternatively, once a particular icon is activated and the corresponding function is activated, view area 608 can display the same view as 3-D planetary view 704, until the user clicks-through a control button on control panel area 606 and activates sub-functions within that function.

Icons 706 convey information to a user on many different levels, relating to, for example, the functions that each icon executes and the relationships between each individual icon. In one embodiment, icons 706 contain pictures that represent their functions. In another embodiment, related icons contain similar pictures or the same picture. In another embodiment, different colors convey functions and relationships. For example, icons having functions that act on the same body of content may all be the same color.

The grouping of icons 706 can also convey functions and relationships. For example, icons 706 could be both planets and moons, where a larger planet represents a major function and smaller moons grouped around the larger planet represent more minor functions related to the major function. As another example of grouping icons 706, a large planet (e.g., the sun) could represent a central function or web page (e.g., home page or central database), with smaller planets positioned around the large planet in a solar system configuration. The large planet could represent the “home base” of the web site at which major functions are executed, and the smaller planets could represent peripheral locations at which other functions are executed.

As a whole, window 700 provides an innovative navigational tool that enables a user to determine a relative and an absolute positioning of where the user is in the overall map of available functions. Indeed, it has been demonstrated that humans process information best when they are able to view the information in context. The GUI navigation tool of the present invention allows users to understand information based on how the information is presented in context, i.e., within the “universe” of a web site).

In a representative embodiment, the user's location is depicted as a spaceship next to the planet representing the particular function with which the user is currently working. The remaining available functions are the other planets in the solar system. At any time, a user can view her current function, can view the other available functions, and can easily jump to those functions by clicking through an icon on map view 702 or 3-D planetary view 704.

The unique approach embodied in location indicator area 610 and window 700 also provides significant practical benefits for the operation of the web site. First, this navigation tool eliminates the need for the conventional left navigational bar, allowing that area to be devoted to a running user-friendly tutorial (tactical area 604). Thus, a user can obtain help from tactical area 604 without having to launch a separate help program, as is prevalent with traditional web sites and software such as Microsoft Word™.

Second, the navigation tool of window 700 enables a web site administrator to more easily add new content and functions. Rather than expanding a conventional left navigational bar such that a user must scroll to find available functions, the present invention simply adds an icon to the map, giving the user the ability to quickly scan all available functions and to identify and activate a particular function. In this way, the navigational aspects of the present invention become transparent so that the user can concentrate on complex activities occurring in view area 608.

Third, the navigation tool of window 700 can provide a functional and navigational layer on top of the functions provided in page 600 through control panel area 608. For example, control panel area 606 can be configured to enable a user to execute small steps of related functions that manipulate the same content. In contrast, a user can use window 700 to jump between divergent functions that act on different bodies of content. Thus, a user can make local or global jumps.

As an example of these local or global jumps, a quest creator could be engaged in creating a quest. In such an exercise, control panel area 606 could provide buttons for functions such as defining the quest mission and creating quest references (e.g., URLs). The questor could jump locally between these functions by clicking through either of the buttons. At the same time, the user could use the navigation tool of window 700 to jump from the function of creating a quest to another function, such as collaborating with other quest creators. Collaborating with other quest creators does not act on the bodies of content that creating a quest does, and represents a wholly different function. Thus, the navigation tool of window 700, in this example, enables the user to make a global jump to another function, while control panel area 606 facilitates local jumps.

As a final exemplary benefit of the navigation tools of the present invention, the navigation tool of window 700 provides a visualization tool through which a user can more easily understand the structure and functions of a web site. The map views of window 700 illustrate how, conceptually, the functional pieces of the web site fit together. Thus, the present invention integrates a user's understanding of the interrelation of various subject areas of a web site with how to actually manipulate the site.

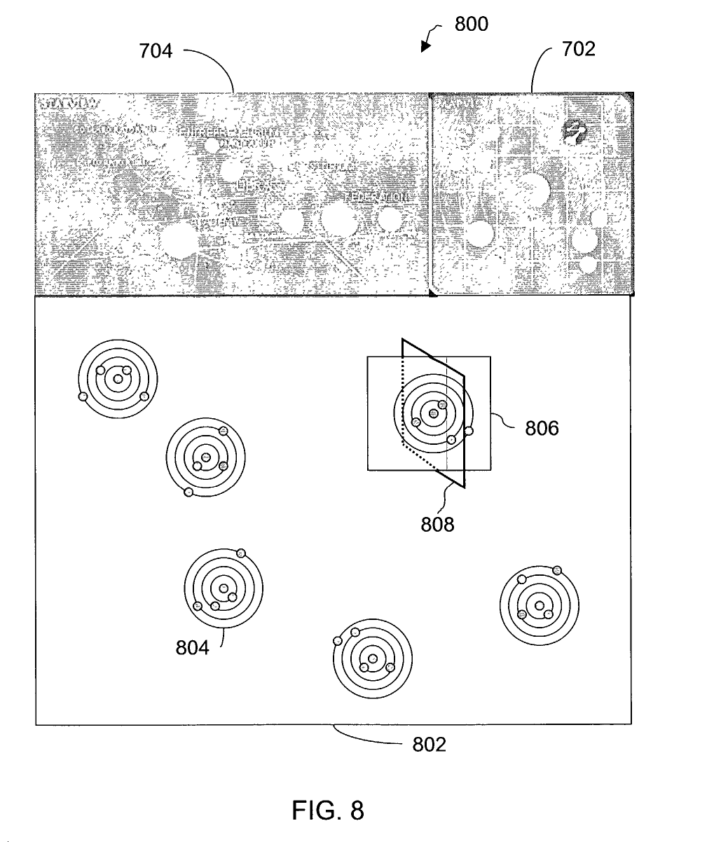

FIG. 8 shows a further embodiment of the navigation tool of the present invention. Here, in addition to map area 702 and 3-D planetary view 704, window 800 includes a universe view 802. Universe view 802 provides a further means for expanding the content of a web site in a manner still easily understandable to a user.

Universe view 802 displays a universe encompassing multiple solar systems 804. Each solar system can represent a distinct body of content and distinct associated functions. The relative positioning of each solar system can illustrate the functional relationships and information relationships between each solar system. Thus, for example, two solar systems that apply different functions to the same database of information can be positioned close to each other. Likewise, solar systems that apply different functions to wholly different databases of information can be positioned far from each other.

As an example of the relationships conveyed in universe view 802, one solar system could be devoted to education, providing functions for creating and sharing quests and clusters. This first solar system would access databases that store the quests and clusters. A second solar system could be devoted to volunteer organizations, providing functions for creating volunteer projects and matching the volunteer organizations with resources and volunteers needed to complete those projects. This second solar system would access databases separate from those of the first solar system. Rather than the quests and clusters, the databases of the second solar system would include, for example, data on available donations of supplies and volunteers' time. Thus, in this case, with different functions and separate bodies of content (databases), the solar systems would be positioned far from each other on universe view 802.

Continuing the example, a third solar system could be devoted to corporate training, providing functions for creating and administering training programs using quests and clusters. This third solar system would have functions distinct from the first two, but could access some or all of the same databases accessed by the first solar system, i.e., education and corporate training could use some of the same content. Thus, with different functions, but with some similar bodies of content, the third solar system would be positioned closer to the first solar system than the second solar system would be to the first solar system.

In FIG. 8, according to an embodiment of the present invention, when a user clicks on a solar system 804 of universe view 802, map view 702 and 3-D planetary view 704 change to display the chosen solar system. The user can jump from solar system to solar system as desired. After finding a desired solar system, the user could then click through the icons of map view 702 and planetary view 704 to activate a desired function.

In another embodiment of the present invention, universe view 802 depicts each solar system 804 in three dimensions, as a combination of the views shown in map view 702 and 3-D planetary view 704. Frames 806 and 808 illustrate this unique view. Frame 806 represents the view of map view 702. Frame 808 represents the view of 3-D planetary view 704.

With this three-dimensional representation, a user could activate function icons through universe 802, instead of using map view 702 and 3-D planetary view 704. For example, the system could display solar systems 804 in two dimensions initially. Then, as the user drags her mouse pointer over a solar system, the system could display that particular solar system in three dimensions, along with its corresponding map view 702 and 3-D planetary view 704 above. Then, with the pointer still over the solar system, the user could activate an icon within the three-dimensional solar system view of universe view 802, instead of activating the icon in map view 702 or 3-D planetary view 704.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, unless that order is explicitly described as required by the description of the process in the specification. Otherwise, one skilled in the art can readily appreciate that the sequences may be varied and still remain within the spirit and scope of the present invention.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

What is claimed is:

1. A method for disseminating knowledge over a computer network comprising:
receiving information from a first user, wherein the information defines a quest;
storing the information in a quest record that is marked with a unique identifier, wherein the quest record is accessible to a plurality of users;
receiving, from the first user, instructions to associate the quest with network addresses of resources available through the computer network;
storing the network addresses in tag records, wherein the tag records reference the unique identifier;
receiving a request to take the quest from a second user;
retrieving the quest record associated with the quest;
determining the unique identifier of the quest record;
identifying tag records that reference the unique identifier;
displaying, to the second user, network addresses of the tag records that include the unique identifier; and
providing access to the network addresses of the tag records that include the unique identifier.

2. The method of claim 1, wherein the resources are at least one of an article, a media clip, a report, a picture, and a broadcast.

3. The method of claim 1, wherein the information includes at least one of a title, a mission statement, a classification, questions to be answered by a user taking the quest, a completion checklist, and notes relating to the quest.

4. The method of claim 1, further comprising receiving input from the second user taking the quest.

5. The method of claim 4, wherein the information includes questions to be answered by a user taking the quest, and wherein the input from the second user includes one of answers to the questions and identifications of additional resources.

6. The method of claim 1, wherein access to the resource comprises a hyperlink to the network address.

7. The method of claim 1, wherein access to the resource comprises a download of the resource to a computer in communication with the computer network for offline manipulation.

8. The method of claim 1, further comprising:
receiving, from the first user, key words for the network addresses associated with the quest;
storing the network addresses and their associated key words in a database accessible to a plurality of users; and
enabling the plurality of users to search the key words of the database.

9. The method of claim 8, wherein the information defining the quest includes key words associated with the quest, and wherein the method further comprises storing the quest record in the database accessible to a plurality of users.

10. A method for disseminating knowledge over a computer network comprising:
receiving, from a first user, a description of a task;
receiving, from the first user, an indication to associate the description with a network address of a resource available through the computer network;
storing the description and the network address in a database that is accessible through the computer network;
associating the description with the network address;
receiving a query from a second user to search for a search term in the database; and
if the description of the task includes the search term, displaying the description to the second user and providing the second user with access to the network address.

11. The method of claim 10, wherein the description includes at least one of a title, an objective, and a classification of the task.

12. The method of claim 10, further comprising:
receiving, from the second user, a second network address of a second resource available through the computer network; and
storing the description, the network address, and the second network address in the database as a new record.

13. The method of claim 10, wherein the description includes a question associated with the task, and the method further comprises receiving, from the second user, an answer to the question and storing the answer in the database.

14. The method of claim 13, wherein the question and the access to the network address are displayed together.

15. The method of claim 10, wherein the resource is a web page.

16. The method of claim 10, wherein the description includes at least one of a title, a mission statement, a classification, questions to be answered by the user completing the lesson, a completion checklist, and notes relating to the lesson.

17. The method of claim 10, further comprising restricting access to the description to designated users.

18. The method of claim 10, further comprising receiving, from the second user, a rating of the description and the resource after the user completes the task, and relating the rating to users viewing the description and the resource.

19. The method of claim 10, wherein the description is displayed to the second user by downloading the description and the resource to the second user.

20. A system for administering a quest comprising:
(a) a computer network accessible to a plurality of users;
(b) a quest database containing quest records, wherein a quest record contains a unique identification;
(c) a tag database containing resource records, wherein a resource record contains:
a network address associated with a particular resource available through the computer network, and
a unique identification of a quest record with which the resource record is associated; and
(d) a computer in communication with the computer network, the quest database, and the tag database, wherein the computer is adapted to retrieve from the quest database a quest record having a designated unique identification, to search the tag database for resource records containing the designated unique identification, and to display resources of the resource records containing the designated unique identification.

21. The system of claim 20, wherein a resource record further contains one of a description associated with the particular resource, a classification associated with the particular resource, and identifications of quest records associated with the particular resource.

22. The system of claim 20, wherein the quest record further contains one of a title, an objective, a category, and a flag indicating whether any associated resources exist.

23. A method for disseminating knowledge over a computer network comprising:
receiving, from a first user, a network address of a resource available over the computer network;
receiving, from the first user, a classification term identifying the resource;
storing the network address with the classification term in a database accessible to a plurality of users;
receiving, from a second user, a search query asking for network addresses relating to a search term;
searching the database for the search term; and
displaying the network address designated by the first user if the classification term is equivalent to the search term.

24. The method of claim 23, further comprising:
receiving, from the first user, a description of the resource;
storing the description with the network address in the database; and
displaying the description with the network address designated by the first user if the classification term is equivalent to the search term.

25. The method of claim 23, wherein the computer network is the World Wide Web and the resource is a web page.

26. The method of claim 25, wherein the web page includes at least one of an article, a curricula, a media clip, a report, a picture, a chart, an event, a network broadcast, and a transcript of collaborations between network users.

27. The method of claim 23, wherein the network address is a Uniform Resource Locator.

28. A method for cataloging web pages available on the World Wide Web comprising:
receiving, from a plurality of users, Uniform Resource Locator addresses of web pages;
receiving, from the plurality of users, classifications of the web pages;
storing the addresses with their classifications in a database accessible through the World Wide Web;
receiving, from a user, a query for web pages related to a search term;
searching the classifications of the database for the search term; and
displaying addresses having classifications containing the search term.

29. The method of claim 28, wherein the classifications are key words.

30. The method of claim 28, further comprising:
receiving, from the plurality of users, descriptions of the web pages;
storing the descriptions with their associated addresses and classifications in a database accessible through the World Wide Web; and
displaying the descriptions along with the addresses having classifications containing the search term.

31. The method of claim 28, wherein a web page of the web pages includes at least one of an article, a curricula, a media clip, a report, a picture, a chart, an event, a network broadcast, and a transcript of collaborations between network users.

32. A method for categorizing content stored on a computer network comprising:
designating a cluster adapted to be associated with resources available through the computer network, wherein the cluster is associated with a user, and wherein the cluster includes at least one category of interest to the user;
creating a record for a resource that is accessible through the computer network;
associating a classification of the resource with the record, wherein the classification corresponds to a category of the at least one category of interest; and
associating the record with the category in the cluster.

33. The method of claim 32, further comprising:
associating a network address of the resource with the tag record; and
associating a description of the resource with the tag record.

34. The method of claim 32, further comprising:
creating a second record for a second resource that is accessible through the computer network;
associating a second classification of the second resource with the second record, wherein the second classification corresponds to a second category of the at least one category of interest; and
associating the second record with the second category in the cluster.

35. The method of claim 32, further comprising:
creating a second record for a second resource that is accessible through the computer network;
associating the classification with the second record; and
associating the second record with the category in the cluster.

36. The method of claim 32, further comprising providing other users with access to the cluster.

37. The method of claim 32, further comprising providing the user with sole access to the cluster.

38. The method of claim 32, further comprising:
displaying the at least one category of the cluster to other users;
receiving a request from a requesting user to view a requested resource associated with the at least one category;
receiving a response from the user relating whether the requesting user is authorized to view the requested resource; and
providing the requesting user with access to the requested resource if the requested user is authorized.

39. The method of claim 32, wherein the resource is a web page.

40. The method of claim 32, wherein before associating the record with the category in the cluster, the method further comprises prompting the user for approval to associate the record with the category.

41. The method of claim 32, further comprising:
designating a second cluster adapted to be associated with resources available through the computer network, wherein the second cluster is associated with a second user, and wherein the second cluster includes a second category of interest to the second user, wherein the second category is relevant to the at least one category of interest to the user;
prompting the user for approval to add the second category to the cluster of the user; and
associating the second category with the cluster if the user approves.

42. A user interface for navigating through a web site on a computer network comprising:
(a) a view area adapted to display content of the web site, wherein the view area is fixed in a first location on the user interface, and wherein the content scrolls within the view area;
(b) a header area adapted to receive commands to execute functions relating to the web site, wherein the header area is fixed in a second location on the user interface;
(c) a tactical area adapted to display instructions related to the content displayed in the view area, wherein the tactical area is fixed in a third location on the user interface, and wherein the tactical area updates the displayed instructions as the content displayed in the view area changes; and
(d) a control panel area adapted to receive commands to execute functions in the view area, wherein the control panel is fixed in a fourth location on the user interface, and wherein the control panel updates functions available to a user based on the content contemporaneously displayed in the view area.

43. The user interface of claim 42, further comprising a location indicator area adapted to provide access to a navigation tool for navigating the web site, wherein the location indicator area is fixed in a fifth location on the user interface.

44. The user interface of claim 42, further comprising a location indicator area adapted to display a map of the functions available on the web site and to indicate which function the user is currently executing, wherein the location indicator area is fixed in a fifth location on the user interface.

45. The user interface of claim 42, wherein the control panel area includes a first portion and a second portion, wherein the first portion is adapted to receive a command from the user in response to which the tactical area displays more detailed instructions without changing the content in the view area, and wherein the second portion is adapted to receive commands from the user in response to which the content displayed in the view area changes and the instructions in the tactical area change to correspond to the changed content.

46. The user interface of claim 42, wherein the first location is below and adjacent to the second location, wherein the third location is below and adjacent to the second location, wherein the third location is left of and adjacent to the first location, and wherein the fourth location is below and adjacent to the first location and the third location.

47. The user interface of claim 43, wherein the first location is below and adjacent to the second location and the fifth location, wherein the third location is below and adjacent to the second location, wherein the third location is left of and adjacent to the first location, wherein the fourth location is below and adjacent to the first location and the third location, and wherein the fifth location is right of and adjacent to the second location.

48. A user interface for navigating through a web site on a computer network comprising:
(a) a first view area adapted to display icons in a two-dimensional view, wherein an icon corresponds to a function executable on the web site, and wherein the first view area is adapted to receive commands to execute functions corresponding to the icons; and
(b) a second view area adapted to display a three-dimensional view of the icons of the first view area, wherein the three-dimensional view is from a perspective of an icon corresponding to a function being executed.

49. The user interface of claim 48, wherein the first view area receives commands by receiving click-throughs of the icons in the first view area.

50. The user interface of claim 48, wherein the second view area is adapted to receive commands to execute functions corresponding to the icons.

51. The user interface of claim 50, wherein the second view area receives commands by receiving click-throughs of the icons in the second view area.

52. The user interface of claim 48, further comprising a location marker in the first view area, wherein the location marker is located proximate to the icon corresponding to the function being executed.

53. The user interface of claim 48, further comprising a location marker in the second view area, wherein the location marker is located proximate to the icon corresponding to the function being executed.

54. The user interface of claim 48, wherein the icons are grouped to indicate relationships between the functions corresponding to the icons.

55. The user interface of claim 48, wherein the icons are planets of a solar system, wherein the two-dimensional view is a top view of the solar system, and wherein the three-dimensional view is a three-dimensional view of the solar system.

56. The user interface of claim 55, wherein at least one of the planets is larger than other smaller planets, wherein the larger planet represents a major function, and wherein the other smaller planets represent minor functions.

57. The user interface of claim 48, wherein the icons include a planet and a plurality of moons, wherein the planet represents a major function, and wherein the plurality of moons represent minor functions.

58. The user interface of claim 48, wherein the icons displayed in the first view area and the second view area are a first group of icons, wherein the user interface further comprises a third view area adapted to display the first group of icons in relation to additional groups of icons, wherein the additional groups of icons represent additional functions, wherein the third view area is adapted to receive a command to choose a second group of icons from among the additional groups of icons, and wherein the first view area and the second view area are adapted to display the second group of icons in response to the command to choose the second group of icons.

59. The user interface of claim 58, wherein the icons are planets, wherein the first group of icons is a first solar system, and wherein the second group of icons is a second solar system.

60. The user interface of claim 58, wherein the additional groups of icons are positioned relative to each other in the third view area to indicate functional and informational relationships.

61. The user interface of claim 58, wherein the third view area is adapted to display a three-dimensional view of the first group of icons and the additional groups of icons.

62. The user interface of claim 58, wherein the third view area is adapted to receive a command to execute functions corresponding to the first group of icons and the additional groups of icons.
